(19) United States
(12) Patent Application Publication
(10) Pub. No.: US 2011/0184736 A1
(43) Pub. Date: Jul. 28, 2011

(54) AUTOMATED METHOD OF RECOGNIZING INPUTTED INFORMATION ITEMS AND SELECTING INFORMATION ITEMS

(76) Inventor: Benjamin SLOTZNICK, Mt. Gretna, PA (US)

(21) Appl. No.: 13/013,276

(22) Filed: Jan. 25, 2011

Related U.S. Application Data
(60) Provisional application No. 61/298,400, filed on Jan. 26, 2010.

(51) Int. Cl. G10L 15/00

(52) U.S. Cl. 704/249; 704/231; 704/E15.001

(57) ABSTRACT

Automated methods are provided for recognizing inputted information items and selecting information items. The recognition and selection processes are performed by selecting category designations that the information items belong to. The category designations improve the accuracy and speed of the inputting and selection processes.

### CROSS-REFERENCE TO RELATED APPLICATIONS

This application claims priority to U.S. Provisional Patent Application No. 61/298,400 filed Jan. 26, 2010.

### BACKGROUND OF THE INVENTION

### I. Overview

Conventional speech recognition software uses algorithms that attempt to match the spoken words to a database of potential words stored in the speech recognition software. For example, if there are 100,000 potential words in the database of the software, all 100,000 of the spoken words are made available as potential matches. This large universe of potential matches inhibits the accuracy and speed of the matching process. The 100,000 potential words in this example is what is referred to below as the “target set.” The accuracy is inhibited because many spoken words have a plurality of potential matches (e.g., homophones such as “too,” “to” and “2”; the greeting “ciao” and the food-related “chow,” or words that sound close to each other, and which become even harder to distinguish when spoken with an accent). The speed is inhibited because a large number of potential matches must be compared to find the best match to select, or the best set of matches to present to a user for selection, if this option is employed. The software may further use sentence grammar rules to automatically select the correct choice, but this process reduces the speed even further.

One conventional technique for improving speech recognition is by pre-programming the software to only allow for a limited selection of responses, such as a small set of numbers (e.g., an interactive voice response (IVR) system that prompts the user to speak only the numbers 1-5). In this manner, the spoken word only needs to be compared to the numbers 1-5 and not to the entire universe of spoken words to determine what number the person is speaking.

Preferred embodiments of the present invention differ from the prior art by limiting the target set in a number of different ways, which can also be used in combination with each other, as follows:

1. The user can make various selections to limit the target set. For example, a category of words can be selected (e.g., greetings) before or after the word is spoken to limit the target set. See, for example, FIG. 3. This is also referred to below as “direct selection on-the-fly of a pre-specified limited vocabulary set.” This technique differs from the prior art discussed above because the user makes the selection that results in the limited target set, as opposed to the software being pre-programmed to limit the target set, such as in the example of a system that detects only the numbers 1-5.

2. The system automatically limits the target set based on knowledge of recently received vocabulary during a text-exchanging session(s). For example, the words that are used in an on-going text exchange are statistically much more likely to be used again in the text exchange, so those words are used to limit the target set using the “weighting” embodiment discussed below.

3. The system automatically limits the target set based on knowledge of the identity of participants during a text-exchanging session(s) and their past exchanged vocabulary. The past exchanged vocabulary is maintained in memory. For example, Susie may have a library of past used words, and those words are used to limit the target set using the “weighting” embodiment discussed below. These words would be different than those used by Annie. Also, the identity may include demographic information, such as the age and education level of the participant, and this information may also be used to limit the target set using the “weighting” embodiment discussed below. For example, words that are at or below the grade level of the participant could be more heavily weighted.

4. The system automatically limits the target set based on knowledge of the output modality of the messaging (e.g., output modalities may include text messaging, formal emails, letters). For example, “mo fo” is a well-known phrase sometimes used in text messaging, but would not likely be used in formal emails or letters. Accordingly, in a text messaging mode, such a modality would be used to limit the target set using the “weighting” embodiment discussed below. If no output modality is designated, the system would struggle to match this phrase to the correct word, and would likely select an incorrect potential match.

Three alternative embodiments of “target set limiting” are as follows:

1. Numerical limiting of the target set (e.g., only 1,000 of the 100,000 target set words are potentially correct matches).

2. Weighting of the full target set (e.g., 1,000 of the target set words are more heavily weighted than the remaining 99,000 target set words—none of the target set words are eliminated, but a subset of the target set are weighted as being more likely to be matches).

3. Dynamic target set limiting. During the sessions, information such as demographic knowledge can be inferred as the session progresses, thereby providing a dynamic target set limiting model. For example, the grade level of the participant can be inferred from past words.

### II. Additional Background

The present invention facilitates the accurate input of text into electronic documents with special improvement of text entry when the user cannot employ rapid and accurate keyboard entry or when the user cannot accurately deploy speech recognition technologies, handwriting recognition technologies, or word prediction technologies. Some conditions when the present invention delivers improved precision and accuracy include when the user does not have good touch-typing skills, when the user does not have good spelling skills, when the user does not have good hand motor coordination, when the user has spastic, atrophied, or paralyzed hands, when the user has a frozen voice box, when the user has one of a variety of diseases or disabilities such as ALS which attenuates or precludes intelligible (or at least tonally consistent) speech, and when the user is not literate or has difficulty reading and writing. The present invention may find application and embodiment in a variety of fields, including the improvement of speech recognition technologies (including cell phone technologies), handwriting recognition technologies, word prediction (i.e. spelling through alphabetic keyboard entry) technologies, and assistive technologies for people with disabilities, including augmentative and assistive communication technologies and devices. Individuals with some of the following disabilities can benefit from the present invention: print disabilities, reading disabilities, learning disabilities, speech disabilities.

The present invention is useful for a variety of reasons, but one of which includes the niche-driven training, product development, and expertise of practitioners in the respective fields. Practitioners in the assistive technology field design for niche markets—for individuals with only one, or at most two, distinct disabilities, assuming that the individuals' other abilities are intact. When the concept of universal design is considered, it is considered one disability at a time, so the situation of individuals with some (but not necessarily total) impairment with respect to a variety of disabilities is not considered. This is especially true with the case of cognitive limitations which accompany many multiple disability conditions. It is also the case that many people with some motor and cognitive impairment have some loss of speech articulation and intelligibility. This niche-centric view is also the case for speech recognition technology which employs a no-hands paradigm that seeks to make finger entry superfluous. This is certainly useful when employing a cell phone while driving a car, but the paradigm ignores many conditions where speech recognition has not been implemented successfully.

In contrast to prior art techniques, the present invention tries to make use of all of each individual's abilities, even if some of them are limited or impaired.

### Using Reduced Vocabulary Set to Increase Accuracy

It is well known that speech recognition technologies can improve their accuracy substantially when the set of possible words to be recognized is restricted. For example, if the user is requested to say a number from one to ten, accuracy is much greater than if the technology must recognize any possible word that the user might say. This is how (and why) speech recognition technology has been so successfully deployed in telephone-based help desks (e.g., “say 1 if you want service and 2 if you want sales”). It is easier to match the single word that is voiced to the small set of distinct choices, than when the program has to match what is voiced to the entirety of a language. The success of speaker-independent speech recognition from sets of pre-specified limited vocabularies contrasts with the difficulties of speech recognition in a large-vocabulary context of unconstrained continuous speech, especially for people who have accents or do not speak distinctly. This is how (and why) speech recognition technology has been more successful in giving a limited set of commands to a computer than in taking dictation, and how (and why) cell phone dialing by speaking a contact's name (from a limited contact list) is more accurate than dictating a general text message. The limited set can be effectuated by actually reducing the set of possible matches, but similar results can be achieved by assigning significantly increased probability weights to this set of possible matches.

The same type of increased accuracy can be obtained through other technologies that employ pattern recognition, such as word prediction and handwriting recognition, by restricting the set of possible matches.

### Using Direct Selection to Enhance Accuracy

Direct selection refers to the user physically activating a control. This includes pressing a physical button or pressing what appears to be a button on a computer's graphical interface. It also includes activating a link on a computer screen, but is not limited to these methods. Direct selection on a computer interface is accomplished through use of a keyboard, special switches, a computer mouse, track-ball, or other pointing device, including but not limited to touch screens and eye-trackers. In the assistive technology field, direct selection is accomplished in some cases through switch scanning methods, or even implantations of electrodes to register a user's volitional action. It is distinguished from the software or computer making the choice.

In the assistive technology field, the user often uses direct selection to pick a particular letter, word or phrase from a list of phrases. The user also may use a series of direct selections to narrow the choices to a set of words or utterances from which the user ultimately chooses via direct selection. For example, the user may directly select (from many sets of words or concepts) the set of body parts, then from that set directly select the set of facial body parts, then directly select the word “eyes”. Each set may be represented by a list (or grid) of words. For some users (especially those who have difficulty reading) the words or sets may be represented by pictures. In the case of specific concrete physical items, such as body parts, pictures can be particularly helpful. But in other cases, where many phrases have equivalent meaning or contextual linguistic purpose, they cannot be differentiated by pictures. For example, the following informal greetings start many conversations (including electronic text messaging and instant messaging), but have the same meaning, and would most likely require the same picture representation: “hi”, “hi ya”, “hi there”, “hey”, “hey there”, “yo”, “caio”. Likewise, the following polite expressions of regret have the same meaning in a conversational context: “sorry”, “excuse me”, “my fault”, “I apologize”, “shame on me”, “my bad”.

If an individual could choose a word, phrase or text utterance entirely through a series of direct selections, then one preferred embodiment of the present invention eliminates one or more of those selections or keystrokes, by reducing the set of possible matches for the recognition or prediction software to consider.

On the other hand, if the individual does not have the ability (or time) to fully specify the text utterance—perhaps because the final step requires a reading ability that the user does not possess—then another preferred embodiment of the present invention allows the user to narrow the set of choices (for example by picture based selections) so that the recognition or prediction software will increase accuracy. For example the greeting “ciao” is pronounced the same way as the word “chow” which means food. A non-reader could not choose between them. However, a direct selection of a “greetings” set of words versus a “food” set of words would give speech recognition software enough information to correctly identify the word.

Even if the user is literate, use of picture based icons in conjunction with spoken words could increase the speed and accuracy of the speech recognition. Notice also that the user could speak first, and then use direct selection to reduce the vocabulary set if the speech recognition software has a lower level of confidence in what the user said.

By combining several abilities (speech, sight, cognition and direct selection) preferred embodiments of the present invention improve the accuracy of user generated text compared to the user employing only one ability.

Preferred embodiments of the present invention are in contra-distinction from current speech recognition technology which tries to recognize a spoken word and then may give the user some alternative word choices or spellings (as in homophones which sound the same but are spelled differently, such as “to” and “too”) from which to choose. (It is also in similar contradistinction from current handwriting recognition, word prediction and assistive technologies which operate similarly.) This prior art allows the user some input, but does not narrow the choice set which the speech recognition software compares to obtain the best fit.

### BRIEF SUMMARY OF THE INVENTION

One preferred embodiment of the present invention applies speech recognition technologies to a reduced set of possible words, by reducing the target set of words prior to invoking the speech recognition algorithm, and does that reduction through user interaction based upon one or more of the following methods: (1) direct selection on-the-fly of a pre-specified limited vocabulary set, (2) automated knowledge of recently received vocabulary in the course of a text-exchanging situation, and (3) automated knowledge of the identity of participants in a text exchanging situation and their past exchange vocabulary.

A second preferred embodiment of the present invention applies handwriting recognition technologies to a reduced set of possible words, by reducing the target set of words prior to invoking the handwriting recognition algorithm, and does that reduction through user interaction based upon one or more of the following methods: (1) direct selection on-the-fly of a pre-specified limited vocabulary set, (2) automated knowledge of recently received vocabulary in the course of a text-exchanging situation, and (3) automated knowledge of the identity of participants in a text exchanging situation and their past exchange vocabulary.

A third preferred embodiment of the present invention applies word prediction technologies to a reduced set of possible words, by reducing the target set of words prior to invoking the word prediction algorithm, and does that reduction through user interaction based upon one or more of the following methods: (1) direct selection on-the-fly of a pre-specified limited vocabulary set, (2) automated knowledge of recently received vocabulary in the course of a text-exchanging situation, and (3) automated knowledge of the identity of participants in a text exchanging situation and their past exchange vocabulary.

A fourth preferred embodiment of the present invention is designed for situations where speech recognition, handwriting recognition, and alphabetic keyboard entry (i.e. word prediction based on attempted spelling) may not be feasible or accurate, by combining direct selection of words and phrases (often with pictorial representations of the words or phrases and often from pre-specified limited vocabulary sets), with one or more of the following methods: (1) automated knowledge of recently received vocabulary in the course of a text-exchanging situation, (2) automated knowledge of the identity of participants in a text exchanging situation and their past exchange vocabulary, and (3) non-pictorial graphical patterns or designs that singly or in combination clearly and uniquely identify each of the words or text objects in the target set.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIG. 1 is a flowchart of a preferred process of using direct selection of vocabulary sets to aid speech recognition by making the direct selection before speaking.

FIG. 2 is a flowchart of a preferred process of using direct selection of vocabulary sets to aid speech recognition by making the direct selection after speaking.

FIG. 3 shows words grouped into vocabulary sets, and picture-based icons associated with those sets.

FIG. 4a shows vocabulary sets shown in FIG. 3 displayed as links for direct selection.

FIG. 4b shows the vocabulary sets which are subsets of those displayed in FIG. 4a, as links for direct selection.

FIG. 5a shows virtual buttons with icons associated with the vocabulary sets shown in FIG. 3, displayed for direct selection.

FIG. 5b shows virtual buttons with icons associated with vocabulary sets which are subsets of those displayed in FIG. 5a, displayed for direct selection.

FIG. 6a is flowchart of how electronic messages are currently received without the present invention.

FIG. 6b is a flowchart of a preferred process of automatically creating vocabulary sets from electronic messages to enhance speech recognition.

FIG. 6c is a flowchart of an alternate process of utilizing automatically created vocabulary sets from electronic messages to enhance speech recognition, including use of direct selection of vocabulary sets.

FIG. 7a is a flowchart of a preferred process of automatically creating vocabulary sets from the electronic messages involved in an electronic conversation between particular users, in order to aid speech recognition.

FIG. 7b is a continuation of the FIG. 7a flowchart showing the process of automatically associating the participants' conversation vocabulary sets with the direct select vocabulary sets, in order to aid speech recognition.

FIG. 7c is a flowchart which shows the continuation of FIG. 7b and the conclusion of the process begun in FIG. 7a.

FIG. 8a is a flowchart which shows an alternate process of utilizing automatically created vocabulary sets from electronic conversations of particular users to enhance speech recognition, including use of direct selection of vocabulary sets.

FIG. 8b is a flowchart which shows the continuation of FIG. 8a.

FIG. 9a shows four different background patterns on four different virtual buttons.

FIG. 9b shows the four virtual buttons of FIG. 9a, but with a different word from the “exclamatory interjection” vocabulary set displayed on each one.

FIG. 10a shows a grid of sixteen virtual buttons for direct selection arrayed in four rows and four columns It shows a different background pattern for each row of buttons.

FIG. 10b shows a grid of sixteen virtual buttons for direct selection arrayed in four rows and four columns. It consists of FIG. 10a superimposed on 90 degree rotation of itself, so that the background of each virtual button is different, but has a relationship to its column and row.

FIG. 10c shows the grid of sixteen virtual buttons from FIG. 10b, but with a different word from the “exclamatory interjection” vocabulary set displayed on each one.

FIG. 11a shows a grid of sixteen virtual buttons for direct selection arrayed in four rows and four columns. Each button has a background pattern similar to FIG. 10a and a different frame or bevel pattern, so that the combination is different for each button, but has a relationship to its column and row.

FIG. 11b shows the grid of sixteen virtual buttons from FIG. 11b, but with a different word from the “exclamatory interjection” vocabulary set displayed on each one, in a similar manner as FIG. 10c.

FIG. 12a is a flowchart that shows one preferred embodiment of an automated method of recognizing an inputted information item by matching the inputted information item to a target set of potential information items stored in a database.

FIG. 12b is a schematic diagram of the hardware/software elements for implementing the flowchart of FIG. 12b.

FIG. 13a is a flowchart that shows one preferred embodiment of an automated method of recognizing an inputted information item by matching the inputted information item to a target set of potential information items stored in a database.

FIG. 13b is a schematic diagram of the hardware/software elements for implementing the flowchart of FIG. 13a.

FIG. 14a is a flowchart that shows one preferred embodiment of a method for allowing a user to select an information item displayed on an electronic device for communicating the information item to a recipient.

FIG. 14b is a schematic diagram of the hardware/software elements for implementing the flowchart of FIG. 14a.

### DETAILED DESCRIPTION OF THE INVENTION

Certain terminology is used herein for convenience only and is not to be taken as a limitation on the present invention.

### Definitions

The following definitions and explanations are provided to promote understanding of the invention:

information item: an information item may be a spoken utterance (e.g., a spoken word, a spoken phrase, a spoken text portion), a handwritten expression (e.g., a handwritten word, a handwritten phrase, a handwritten text portion), a typed expression (e.g., a typed word, a typed phrase, a typed text portion). (A “text portion” is also interchangeably referred to herein as “text.”)

phatic communication item: an information item that conveys a phatic expression, namely, an expression used to express or create an atmosphere of shared feelings, goodwill, or sociability rather than to impart information.

category: categories may include “types of categories” wherein the type identifies some form of well-recognized grouping of related information items such as “greetings,” “body parts,” and “food items.” Categories may also include “demographic-based categories” wherein one or more demographic factors are used to categorize a person, such as “minors,” “males,” “students,” “retired.” Categories may also include “modality-based categories” that indicate how the information item is being entered or is to be delivered, such as “text messaging,” “emailing,” “speech entry.” Categories may also include “phatic communication categories” denoting speech used to express or create an atmosphere of shared feelings, goodwill, or sociability rather than to impart information. Categories may also include “recently entered information items” and “previously entered information items.” For example, a target set of information items have two categories, namely, one category for recently entered information items that were entered by a specific user, and another category for all of the remaining information items. An information item may belong to one or more categories. For example, a particular phrase may belong to a phatic communication category and may also be a word that is generally used only by students. A word may be a word that was recently spoken by Jane Doe and is also a body part. Target sets may be reduced by using one category or more than one category. If more than one category is indicated, a Boolean operator (e.g. “AND,” OR”) must also be indicated. For example, if the “AND” operator is indicated, then the information item must belong to both categories to be part of the reduced set of information items.

category designation: a category designation as defined herein is the Boolean expression of the one or more inputted categories. If only one category is inputted, the category designation is simply the one inputted category. If more than one category is inputted, the category designation is the Boolean expression of the plural categories. Consider an example wherein only one category is inputted, namely, words spoken recently by Jane Doe. In this example, the category designation is words recently spoken by Jane Doe. Consider another example wherein two categories are inputted, namely words spoken recently by Jane Doe and words that are generally used only when text messaging, and an indication is made that the “AND” Boolean operator should be applied to the categories. Thus, the category designation is words recently spoken by Jane Doe that are generally used only when text messaging.

1. Combining Direct Selection with Speech Recognition

Although different aspects of the present invention can be combined, it is easiest to understand them when they are described one at a time. The first aspect to be described is using direct selection to enhance speech recognition.

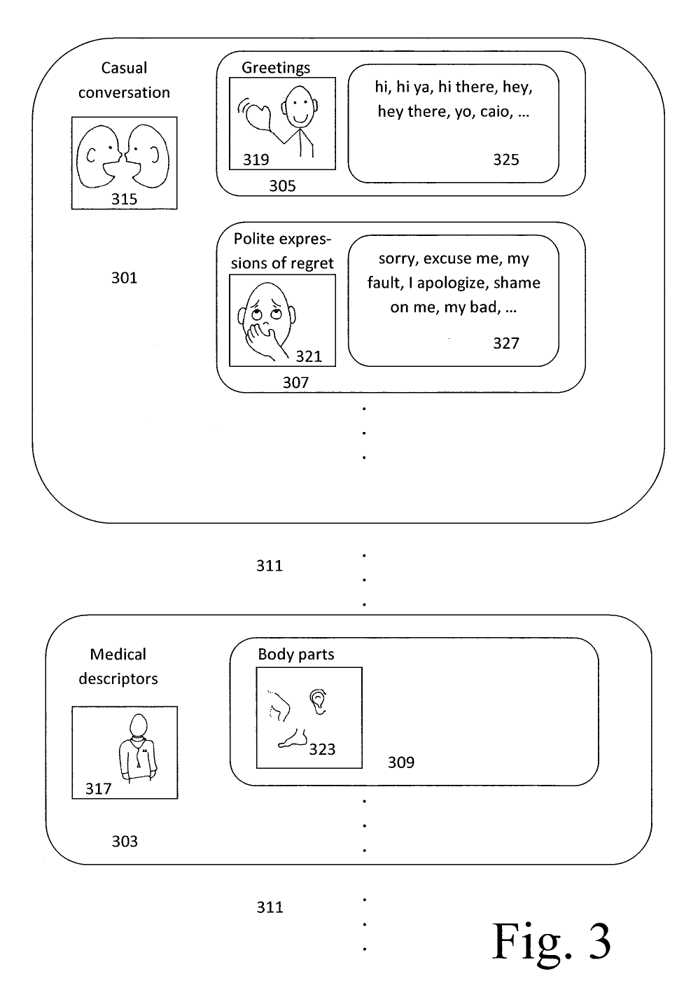

FIG. 3 shows an example of vocabulary sets that may be useful to employ in the present invention. There are many ways to group the words people use into sets, and many words may be members of more than one set. But a particularly useful set of words may be those used in casual conversation, 301, in part the less precise and less structured nature of casual conversation may subconsciously lead a user to use less precise inflection and articulation which the speech recognition technology may find more difficult to distinguish. A subset of casual conversation is the group of greetings, 305, which include many similarly sounding words and phrases that may be more difficult for the speech recognition technology to distinguish. Examples of greetings include: “hi”, “hi ya”, “hi there”, “hey”, “hey there”, “yo”, and “caio”, 325. This subset also includes words and phrases with spellings that would not be used in more formal writings, such as “ya” and “yo”. Other phrases employed in casual conversation use grammatical forms considered incorrect in more formal text. An example is “my bad” (see 327) as a polite expression of regret, 307. Without the use of preferred embodiments of the present invention (recognizing speech of specified sets of words and phrases) training the speech recognition technology to recognize the incorrect grammar of casual conversation may reduce its accuracy in more formal contexts. Likewise, preferred embodiments of the present invention enable the speech recognition technology to recognize different pronunciations of the same word in different contexts, where the contexts are specified by direct selection. For example, when words are used as “exclamatory interjections” (including those describing human excretory functions) they are often spoken with an intentionally distorted pronunciation (at times with extra syllables) and heightened vocal emphasis in comparison to when they are ordinarily used.

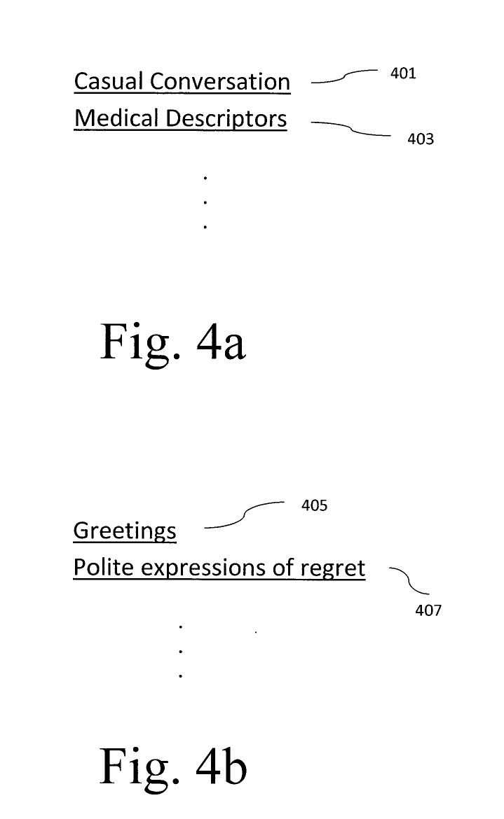

The database constructed to access these vocabulary sets includes not just words and phrases, but the pronunciation and the spelling to be used in this directly selected context. A preferred embodiment of this database includes a word or phrase that describes the database, which is shown on the dynamic display to represent the vocabulary set. For example the vocabulary set 301 has the label “casual conversation”, while one of its subsets 305 has the label “greetings”, and another of its subsets 307 has the label “polite expression of regret”. As another example, the vocabulary set 303 has the label “medical descriptors”, and its subset 309 has the label “body parts”. (See also discussion of FIG. 4a and FIG. 4b.) The methods of constructing electronic databases are well known to practitioners of the art.

In an alternate embodiment, the database contains icons (stored as image files) to be displayed on the dynamic display along with, or instead of, the vocabulary set labels. For example, the picture 315 of the heads of two people talking to each other is used as an icon to represent the “casual conversation” vocabulary set 301. The picture 319 of a stick figure person waving hello is used as an icon to represent the “greetings” vocabulary subset 305. The picture 321 of a person covering his mouth and looking upward with furrowed eyebrows is used as an icon to represent the “polite expressions of regret” vocabulary subset 307. The picture 317 of a figure with white coat and stethoscope is used as an icon to represent the “medical descriptors” vocabulary set 303. The picture 323 of an arm, an ear, and a foot, is used as an icon to represent the “body parts” vocabulary set 309. The methods of storing electronic images and including them as items in a database are well known to practitioners of the art.

FIG. 3 uses the three dot symbol 311 to acknowledge that there are many other vocabulary sets (as well as other vocabulary subsets). FIG. 3 does not display greater detail of sets within sets, or supersets that contain these sets. However in alternative embodiments, such sets are implemented, with their own labels and icons. As noted above, many words may belong to more than one such set.

FIG. 4a shows how two vocabulary set labels appear on the dynamic display of a preferred embodiment: “casual conversation” 401, the label for the “casual conversation” vocabulary set 301 of FIG. 3, and “medical descriptors” 403 of FIG. 4a, the label for the “medical descriptors” vocabulary set 303 of FIG. 3. They are shown underlined in Arial font, but alternate embodiments display the text in different fonts, different sizes, different colors, different styles, and with or without underlining or embellishment. An alternative embodiment allows the user to select the text font, size, color and style to make the label most readable to the user. In a preferred embodiment the labels (401 and 403) are displayed as clickable links, but alternate embodiments display them as within selectable (and activate-able) areas on the dynamic display. This is intended to be an example rather than a limitation upon how the label is displayed. As is known to knowledgeable practitioners of the art, there are various ways to display text labels so that they can be activated by direct selection.

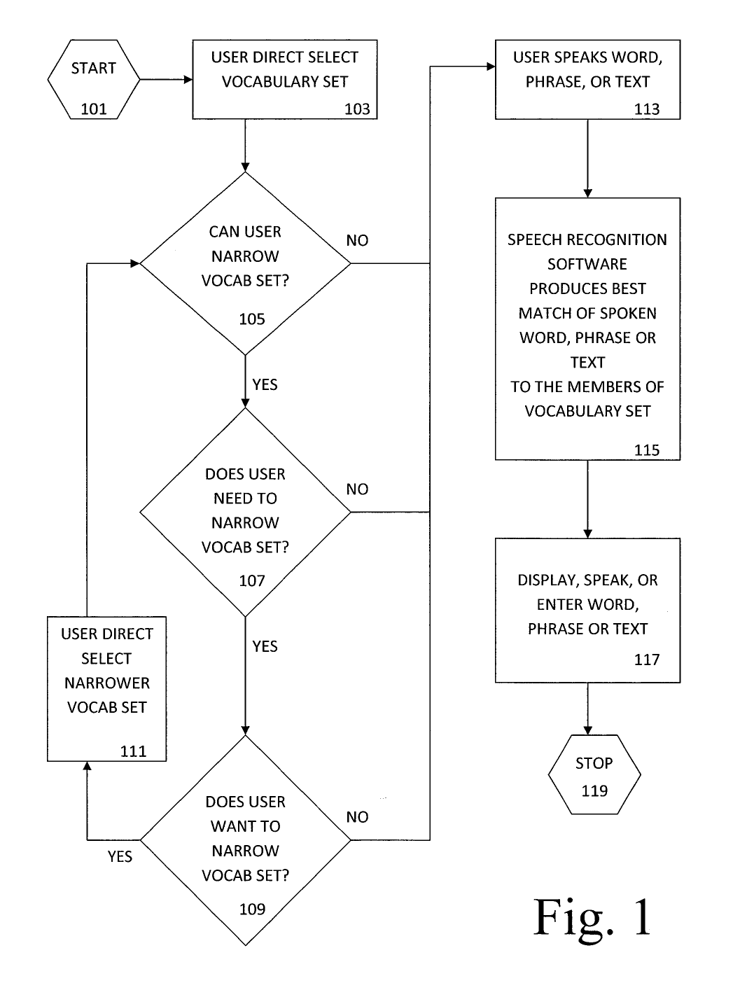

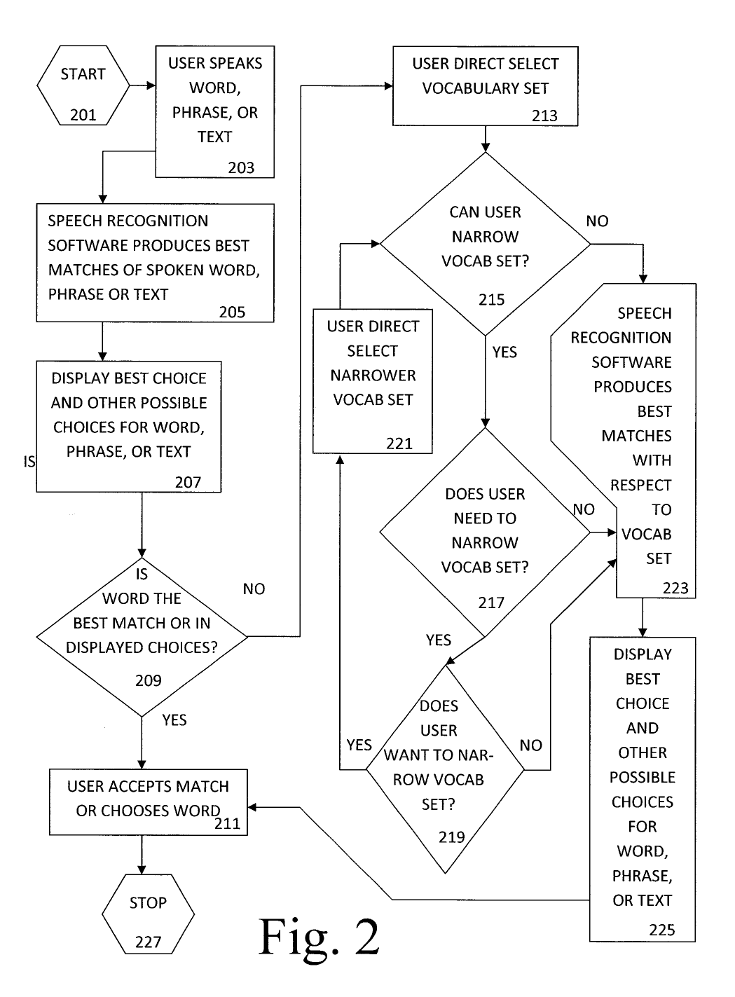

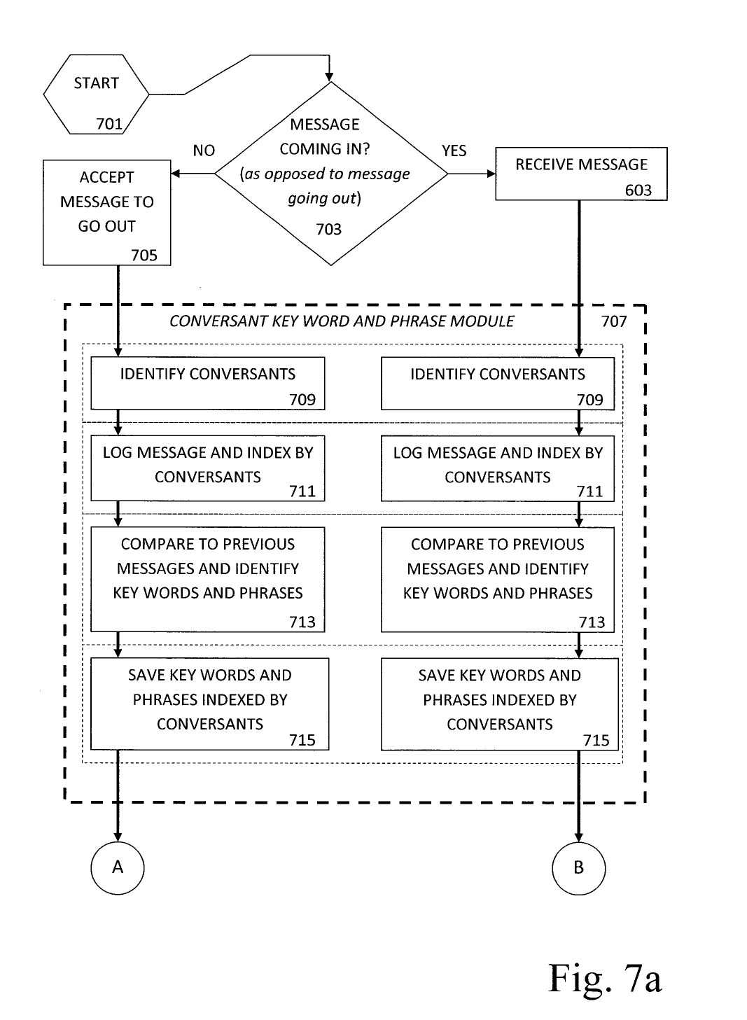

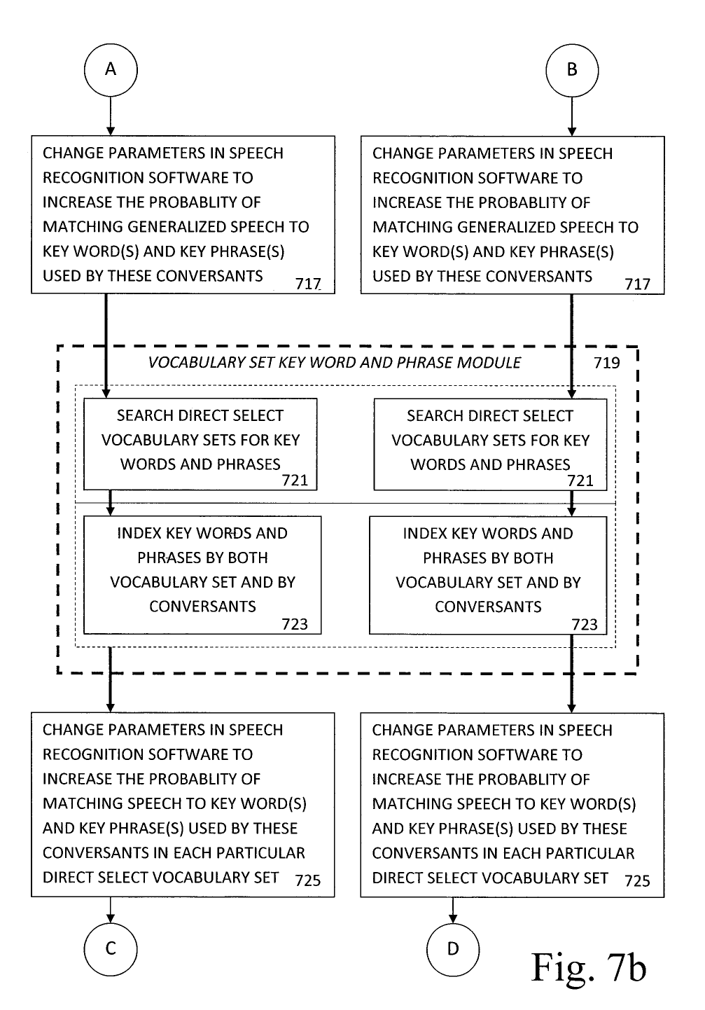

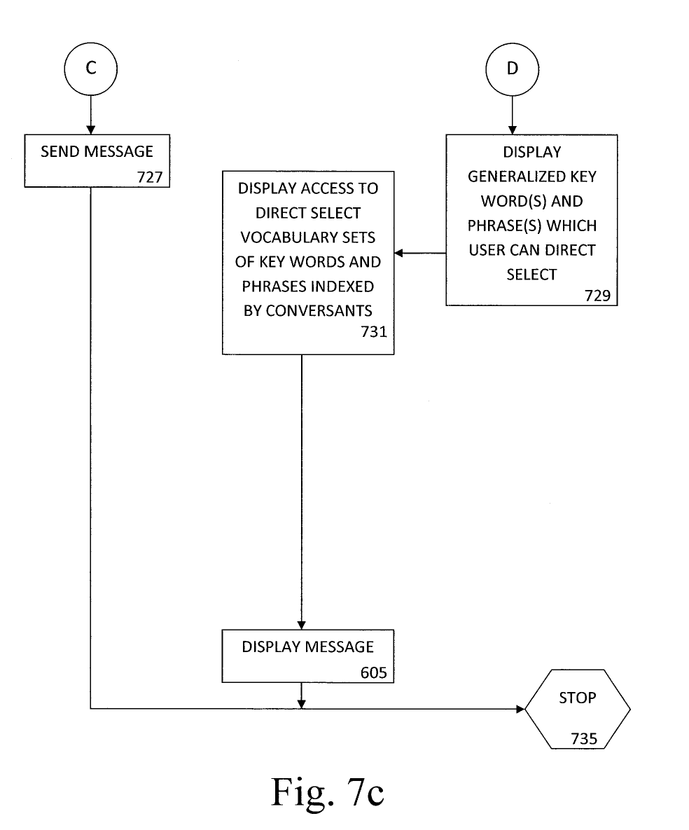

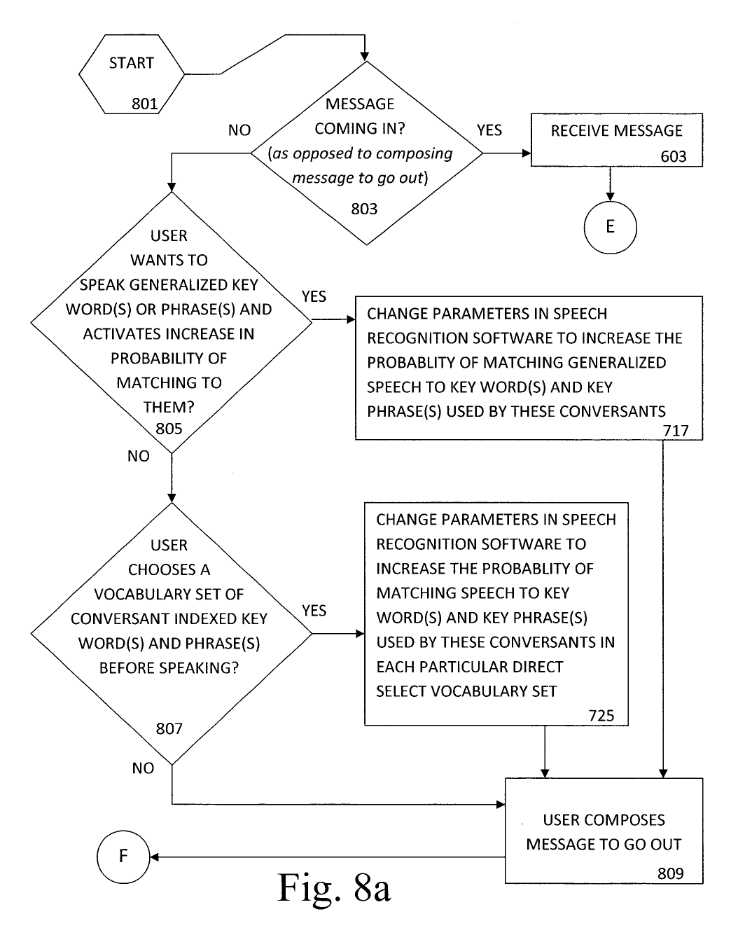

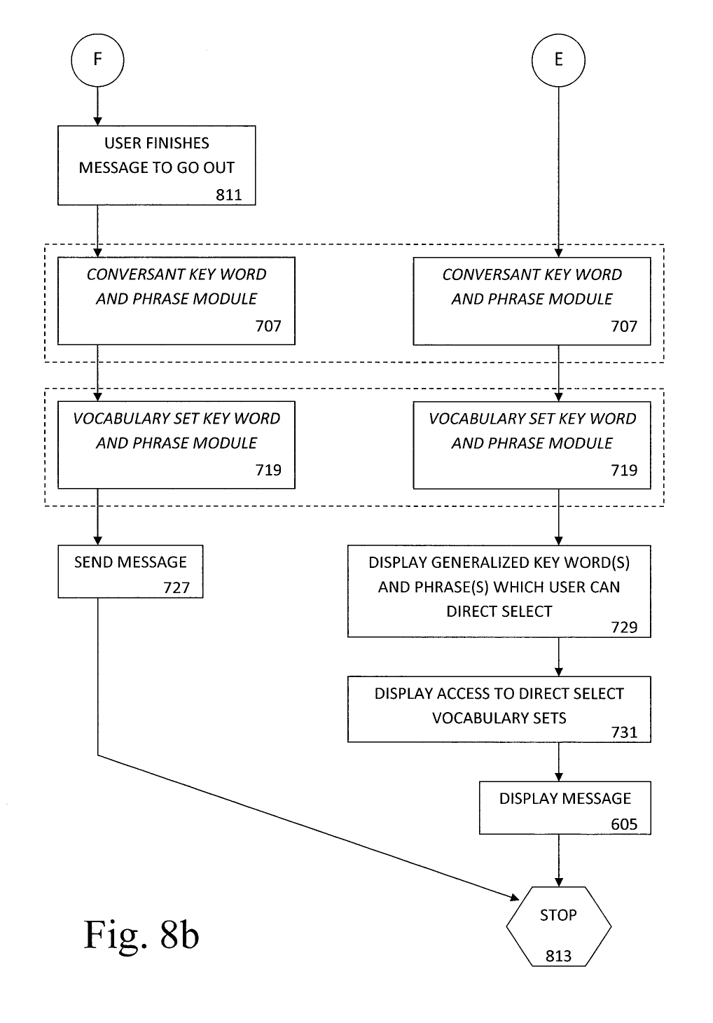

When a label is selected the dynamic display shows the labels of the subsets of that vocabulary set if there are any. For example, selecting “casual conversation” 401 results in the display of FIG. 4b, “greetings” 405, “polite expressions of regret” 407 and any other labels for other subsets of vocabulary words and phrases in the “casual conversation” vocabulary set. The change in labels is accomplished through html links in browser-like interfaces, or selectable areas in a graphics display, or virtual buttons (each showing a text label representing a vocabulary set) or otherwise as known to practitioners of the art. If the vocabulary set that the label references does not contain any subsets, other than its individual elements of words and phrases, then in a preferred embodiment, selecting the label (e.g. 405 or 407) selects the set that the label refers to for purposes of the flowcharts in FIG. 1 (103 and 111), FIG. 2 (213 and 221), and FIG. 8a (807). See also FIG. 7c (731) and FIG. 8b (731).

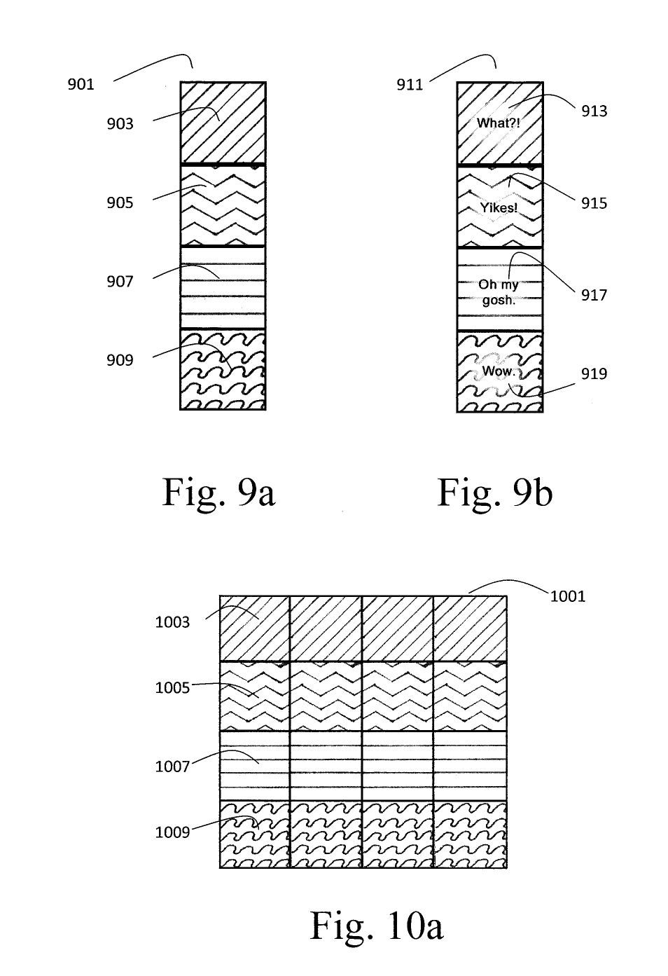

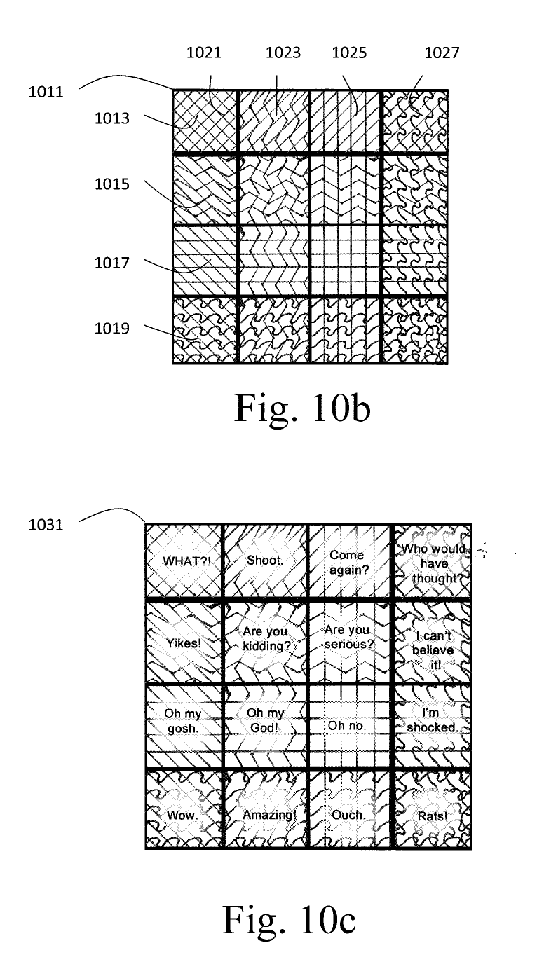

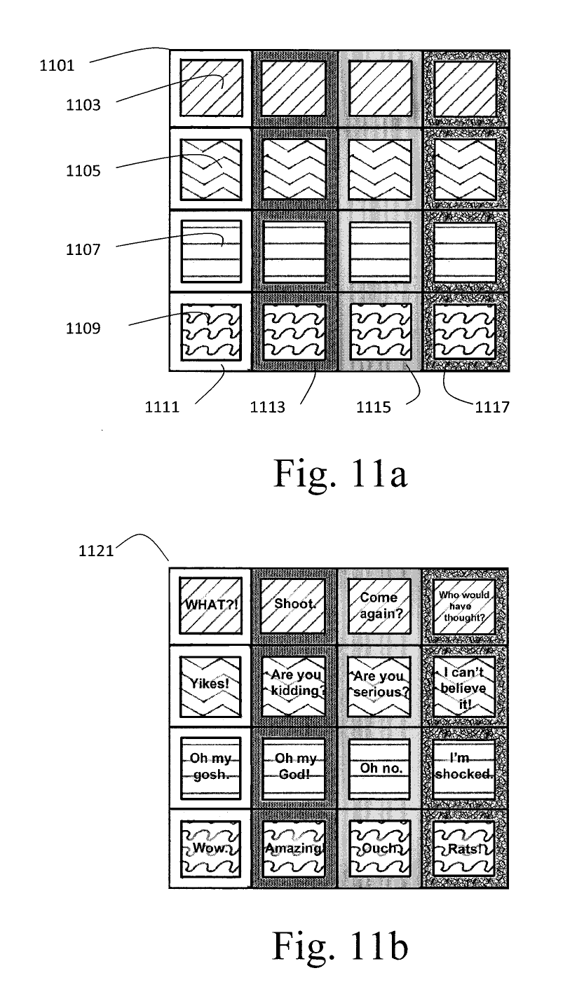

In the preferred embodiment (illustrated in FIG. 4a and FIG. 4b, compare FIG. 9b) the labels are displayed in list form. In an alternative embodiment, the labels are displayed in gird form (compare FIG. 10c and FIG. 11b). In another alternative embodiment, the labels are displayed in an “outline” format (static or expandable) which shows both sets and their subsets (the subsets being indented). Preferred embodiments of the present invention include but are not limited to these methods of display, and are intended to include other methods of display well known to practitioners of the art.

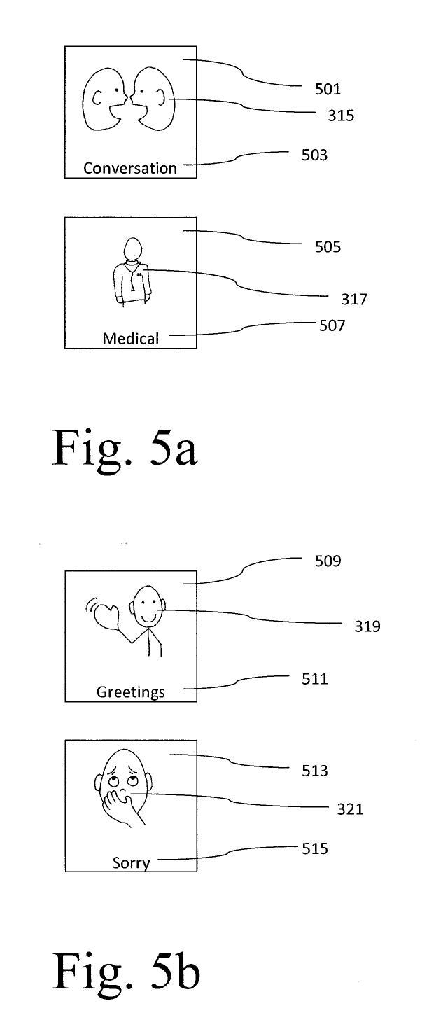

In an alternate embodiment, selectable virtual buttons with picture icons are used on the dynamic display instead of labels. For example, in FIG. 5a, the virtual button 501 performs the same function as label 401 in FIG. 4a. The virtual button 505 in FIG. 5a performs the same function as label 403 in FIG. 4a. The virtual button 509 in FIG. 5b performs the same function as label 405 in FIG. 4b. The virtual button 513 in FIG. 5b performs the same function as label 407 in FIG. 4b.

In FIG. 5a, the button 501 displays the picture 315 that refers to the “casual conversation” vocabulary set 301 in FIG. 3. Button 501 also contains a label 503, here “conversation”, which is a shortened reference to the vocabulary set 301. It is shortened because of the limited space on the button's surface.

Likewise, the button 503 displays the picture 317 that refers to the “medical descriptors” vocabulary set 303 in FIG. 3. Button 503 also contains a label 507, which is also a shortened reference to the vocabulary set 303. Selecting button 501 will cause the two buttons in FIG. 5b (509 and 513) to be displayed. In a preferred embodiment, 509 and 513 replace 501 and 505. In an alternate embodiment 509 and 513 are displayed in addition to 501 and 505.

Looking now at FIG. 5b, the button 509 displays the picture 319 that refers to the “greetings” vocabulary set 305 in FIG. 3. Button 509 also contains a label 511, here “greetings”, which is the same as the reference name of the vocabulary set 305. Likewise, the button 513 displays the picture 321 that refers to the “polite expressions of regret” vocabulary set 307 in FIG. 3. However, button 513 contains a label 515, here “sorry” which is different than the name of the vocabulary set, but reminds the user of the content of the set.

The examples of virtual buttons in FIG. 5a and FIG. 5b each contain both a picture and a label. In alternate embodiments a button will contain only a label, or only a picture.

In the preferred embodiment, selecting a vocabulary set does not display the words in that set. However, in an alternative embodiment, selecting a vocabulary set displays the words in the set. Users with certain disabilities directly select from those words. Other users employ the displayed words to train or correct the speech recognition technology. In other words, if the speech recognition technology chooses an incorrect word from the vocabulary set, the user can make the correction by directly selecting from that set.

Consider now FIG. 1, as the user is about to employ speech recognition software, 101. In a preferred embodiment, the user speaks into a microphone and makes direct selection from items that are shown on a dynamic display (such as a computer screen) using pointing and selection technology including, but not limited to, a computer mouse, track ball, eye tracking (eye-gaze) or head motion sensor, touch screen, or switch scanning. The methods of direct selection are not limited to these technologies, but include those others known to practitioners of the art. Alternatives include displaying a number with each item, so that the user direct selects by using a number keypad, or even voice recognition of digits or voice control of the pointing and selection technology (in this respect recognition of a relatively small number of direct control commands is well known to practitioners of the art as more accurate and of a distinct nature than continuous speech recognition of all utterances). In some embodiments the dynamic display is large. In others, it is small. In others it is incorporated into another device. Examples of such displays include but are not limited to computer monitors, cell phone displays, MP3 players, WiFi enabled devices (such as the iPod® Touch from Apple), GPS devices, home media controllers, and augmentative and assistive communication devices.

Returning to FIG. 1 the user first directly selects a vocabulary set 103, using methods described above and from among interfaces shown in FIG. 4a, FIG. 4b, FIG. 5a, and FIG. 5b, and other functionally equivalent interfaces known to practitioners of the art. The user has the opportunity to narrow the vocabulary set if he or she is able to (105), needs to (107), or wants to (109), in which case the user narrows the vocabulary set by direct selection 111. FIG. 4a and FIG. 4b illustrate how the interface changes when the user narrows the vocabulary set using a text-based or link-style interface (for greater detail see earlier discussion of these figures). FIG. 5a and FIG. 5b illustrate how the interface changes when the user narrows the vocabulary set using a picture based virtual button style interface (for greater detail see earlier discussion of these figures). After narrowing the selection of the vocabulary set, the user speaks the word, phrase, or text to be recognized 113. The speech recognition software then compares what was spoken to the words and phrases in the vocabulary set and produces the best match 115. At that point, the recognized text is processed and displayed on the dynamic display and entered into the appropriate document or file 117. In some embodiments, the word is spoken aloud using synthesized speech as a feedback so that a non-reading user knows what has been entered. The process then ends 119.

In one preferred embodiment, narrowing the vocabulary set consists of an actual reduction in members of the target set. In an alternate embodiment, it consists of a weighting of probabilities assigned to members of the larger target set, which effectively narrows it, as known to practitioners of the art.

In another preferred embodiment, if the user wants more spoken text to be processed by the speech recognition technology, he or she will begin again with 101 and again direct select the vocabulary set. In an alternative embodiment, the user just continues speaking and the speech recognition technology acts as if the same vocabulary set has been selected, until such time as the user directly selects another vocabulary set. In some alternate embodiments, the present invention is employed only when the user is about to speak words or phrases from specific hard to recognize vocabulary sets, and otherwise, the generalized continuous speech recognition technology is employed with no direct selection of a restricted domain.

Consider now the flowchart for an alternative embodiment shown in FIG. 2. Again the user. starts 201, but this time speaks the word, phrase or text before directly selecting a vocabulary set 203. The speech recognition technology produces the best match and alternate possibilities 205. It also saves the speech sampling data for possible recalculation of the match. The best match and possible alternate choices are entered, displayed or spoken for the utterance 207. If the best match (or one of the alternate choices) corresponds to the originally uttered word, phrase or utterance 209, then the user accepts the match or directly selects from among the alternate choices 211. Then the process stops 227.

In an alternative embodiment, if the user continues to input speech, that speech input is taken by the present invention as an acceptance by the user of the best match offered by the software.

However, suppose that neither the proposed match nor any of the proposed alternate choices are the word or phrase that was spoken 209. Then the user direct selects a vocabulary set 213 to narrow the possibilities and increase the accuracy of the speech recognition technology. The user has the opportunity to narrow the vocabulary set if he or she is able to (215), needs to (217), or wants to (219), in which case the user further narrows the vocabulary set by direct selection 221. The speech recognition software uses the saved sampling data to produce the best matches with respect to the reduced vocabulary set 223, and speaks or displays the best match and other possible choices for the utterance 225. The user then accepts the proposed match or chooses among the offered alternatives 211 and the process stops 225.

In an alternative embodiment, the user speaks a longer message. Then considers the text proposed by the speech recognition software from the beginning: word by word (or phrase by phrase). For each particular word, the user either accepts it, or direct selects a vocabulary set to which the software tries to match the word.

2. Combining Direct Selection with Handwriting Recognition.

This embodiment of the present invention is taught and described using FIG. 1, FIG. 2, FIG. 3, FIG. 4a, FIG. 4b, FIG. 5a, and FIG. 5b as generally detailed above, but with the following changes to FIG. 1 and FIG. 2 and corresponding changes to the description of them.

For FIG. 1: Change step 113 from “User speaks word, phrase, or text” to “User writes word, phrase, or text.” Also change step 115 from “Speech recognition software produces best match of spoken word, phrase or text to the members of the vocabulary set” to “Handwriting recognition software produces best match of written word, phrase or text to the members of the vocabulary set”.

For FIG. 2: Change step 203 from “User speaks word, phrase, or text” to “User writes word, phrase, or text.” Also change 205 from “Speech recognition software produces best matches of spoken word, phrase or text” to “Handwriting recognition software produces best matches of written word, phrase or text”. Also change 223 from “Speech recognition software produces best matches with respect to vocab set” to “Handwriting recognition software produces best matches with respect to vocab set”.

3. Combining Direct Selection with Word Prediction

Again, this is word prediction in the context of using an alphabetic keyboard to spell text. This embodiment of the present invention is taught and described using FIG. 1, FIG. 2, FIG. 3, FIG. 4a, FIG. 4b, FIG. 5a, and FIG. 5b as generally detailed above, but with the following changes to FIG. 1 and FIG. 2 and corresponding changes to the description of them.

For purposes of this entire disclosure, the verb “type” is used to mean direct selection of alphanumeric keys from a keyboard-like interface to spell words and enter them into an electronic text format, regardless of whether the keyboard is physical or an on-screen virtual keyboard. An equivalent, but longer verb phrase is “enter individual letters through keyboard-like interface for purposes of spelling words.”

For FIG. 1: Change step 113 from “User speaks word, phrase, or text” to “User types word, phrase, or text.” Also change step 115 from “Speech recognition software produces best match of spoken word, phrase or text to the members of the vocabulary set” to “Word prediction software produces best match of typed word, phrase or text to the members of the vocabulary set”.

For FIG. 2: Change step 203 from “User speaks word, phrase, or text” to User types word, phrase, or text.” Also change 205 from “Speech recognition software produces best matches of spoken word, phrase or text” to “Word prediction software produces best matches of typed word, phrase or text”. Also change 223 from “Speech recognition software produces best matches with respect to vocab set” to “Word prediction software produces best matches with respect to vocab set”.

4. Combining Information from Incoming Text with Speech Recognition

“Conversations,” including exchanges of electronic text messages, repeat words and phrases, and conversants echo each other. These conversations focus on specific things, that is, they use specific nouns including proper nouns which may have unique spellings. They include slang terms with non-traditional spelling. They describe these things using adjectives which may be repeated by responding parties to the conversation. They employ common phatic language, commonly defined as speech or language used to express or create an atmosphere of shared feelings, goodwill, or sociability, rather than to impart information. For example, consider a text message that reads, “chillin at the freakin' mall with roxy before arachnophobia”, which relates that the sender is hanging around the shopping mall with a friend named Roxy before going to see the movie Arachnophobia. A reply is likely to have specific content referencing “Roxy”, “Arachnophobia”, or the “mall” and may also employ the use of “chillin” or “freakin” (misspellings of “chilling” and “freaking”) as phatic communication. The misspellings of “chilling” and “freaking” are an intentional part of the nature of this social setting. (In some electronic social settings such as text messaging, intentional misspellings become even more distinctive such as “gr8” for “great”.)

Using a generalized speech recognition software to compose a reply is likely to misspell the proper nouns, and mistake the phatic phrases because they are being pronounced incorrectly for phatic reasons. If pronounced correctly, the generalized speech recognition spells the words correctly, but that is not correct colloquially (or phatically). If the user “corrects” the spelling for a colloquial use, current speech recognition technology uses this correction to train the software, which trains it to misspell the word during normal non-colloquial use.

Generalized speech recognition technology that employs context to increase accuracy may also be confused by the non-standard phatic use of “freaking” and “chilling”.

It is well know by practitioners of the art, that speech recognition accuracy increases when the set of words it is trying to match is small. It is also well known that accuracy can be increased if certain words are known to occur more frequently, by having the speech recognition software give them a weighted probability that will increase the likelihood that they are chosen.

Preferred embodiments of the present invention teach how to increase the accuracy of speech recognition in an electronic text messaging context by assigning a high probability to the key words in the just received text when using speech recognition to compose a reply. The preferred embodiments of the present invention also permit slang and phatic usages and spellings without introducing inaccuracies when the speech recognition software is employed in a more general context.

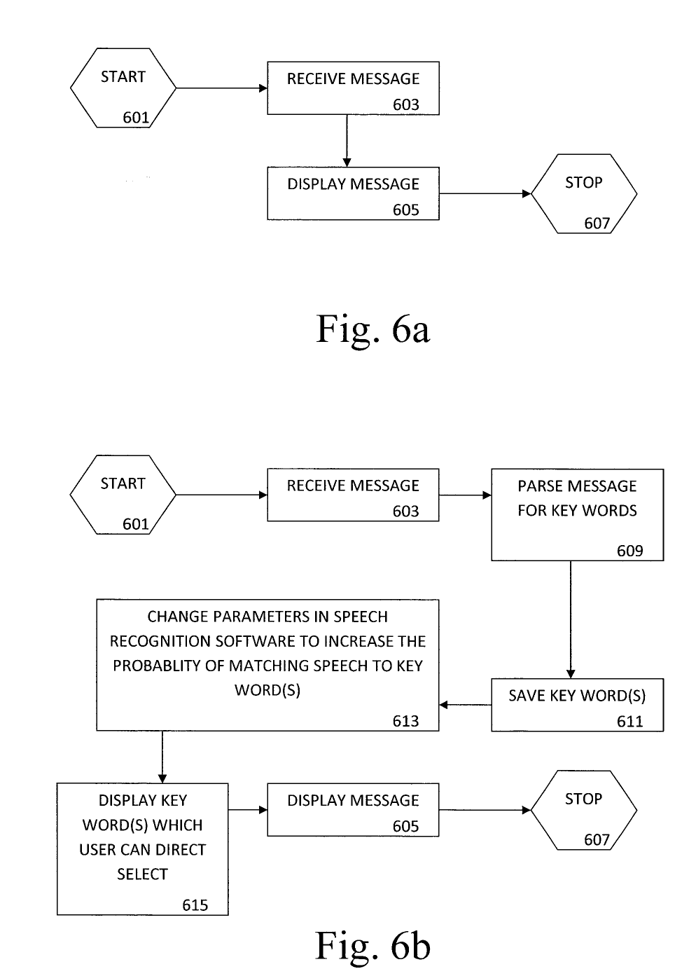

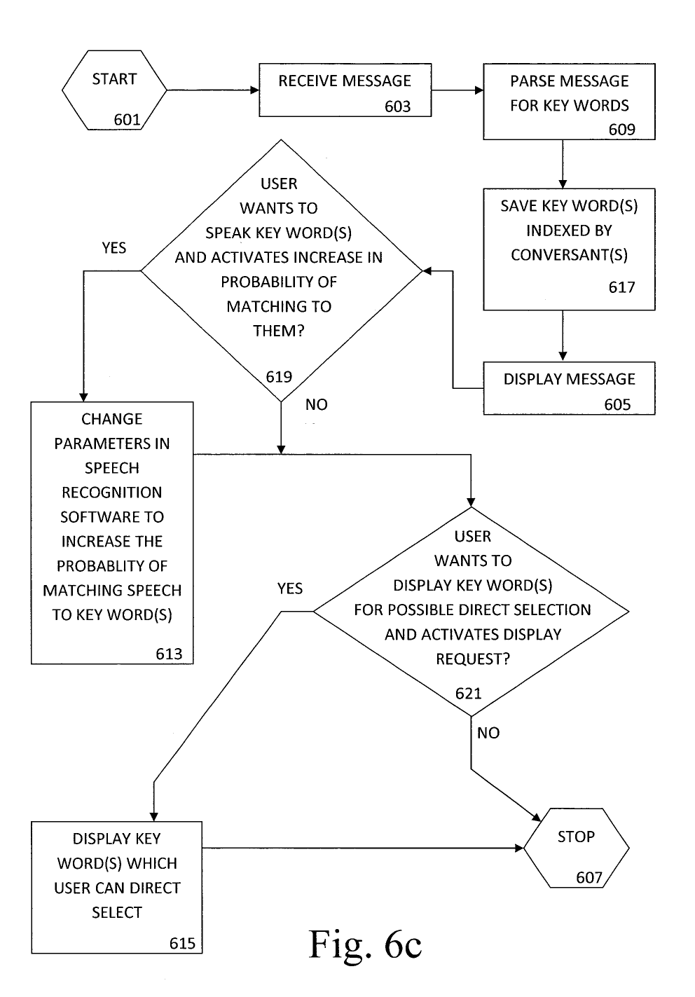

FIG. 6a illustrates what happens when a person receives a text message (whether email, instant message, SMS text message, or otherwise) that does not employ any embodiments of the present invention. At the start of the process 601, the message is received 603 by an electronic device such as a cell phone or computer. Then the message is displayed 605 and the process ends 607. Notice that any speech recognition software is separate and unrelated to the received messages.

In some embodiments, step 605 also includes having the message spoken aloud using computer synthesized speech. In other embodiments designed for poor readers, step 605 includes having the text “translated” into pictures or symbols that the user associates with the words, and then displaying those pictures or symbols with or without the original text.

In contrast, FIG. 6b illustrates what happens when a preferred embodiment of the present invention is employed where speech recognition is used to respond to a text message. At the start of the process 601, the text message is received 603 by an electronic device. The text is parsed into individual key words 609.

The definition of a key word is variable, depending on the embodiment and selectable user preferences. For example, in one embodiment a key word is every word greater than 6 letters. In an alternate embodiment, the criteria is every word greater than 4 letters. In another alternate embodiment, every word that is capitalized is treated as a key word. In another alternate embodiment, a predefined set of words is excluded from key word status. As an example, consider excluding simple words that are frequently used in any conversation, such as “a”, “an”, and “the”.

The key words are saved 611. Then the parameters in the speech recognition software are changed to increase the probability of matching a spoken reply to the key words 613. In preparation for the user composing a response and in anticipation of a spoken reply, the key word or words are shown on the dynamic display 615 so that the user can directly select one if the speech recognition software does not correctly identify it. The message is then displayed 605 and the process ends 607.

Again, in some embodiments step 605 also includes having the message spoken aloud using computer synthesized speech. In other embodiments designed for poor readers, step 605 includes having the text “translated” into pictures or symbols that the user associates with the words, and then displaying those pictures or symbols with or without the original text.

In an alternate embodiment, the individual words in the displayed message are associated with a selectable field (as well known to knowledgeable practitioners of the art), so that the user directly selects them from within the displayed message. For example, if the message is displayed as html text within in an html window, then placing special tags around the words enables them to be selected with clicks and cursor movements (or a finger if it is a touch screen). In an alternate embodiment, the word or phrase in the selectable field can be saved for later use. The user highlights or otherwise placed focus on a particular selectable word or phrase, then activates a “save” button or function, and then activates the desired tag or category. If the passage is being read aloud through computer synthesized voice (perhaps to an individual with reading disabilities), after one of the identified words is spoken (or highlighted and spoken), the user activates a “save” button or function, then activates the desired tag or category. This places the word in the category database for later display with the category of words.

After the process shown in FIG. 6b, and described above, the user dictates a response to a text message, and the speech recognition software more accurately identifies when words contained in the original received message are spoken as part of the response, and more accurately turns those spoken words into a text reply.

In an alternate embodiment, the user selects when the speech recognition software focuses on text from a received message and when it tries to recognize words without such limitation. This increases recognition accuracy in two ways. When the user wishes to speak sentences containing words from the received message, he or she increases accuracy as described above. But when the user speaks on a new topic with new words, accuracy is not decreased by focusing on the words in the received message. In fact, in an alternate embodiment, the act of not focusing on the words in the received message changes the parameters in the speech recognition software to decrease the probability of matching to those words. Thus, accuracy is increased in this instance as well.

In another alternate embodiment, special provision is made for the fact that the user is multi-tasking, and using the speech recognition software to engage in several simultaneous text conversations. In yet another embodiment, special provision is made for the fact that the user is engaging in multiple simultaneous text conversations using different modalities, such as email, SMS texting, and instant messaging. The grammatical, spelling and linguistic conventions of these forms of text communications are all somewhat different, as are the grammatical, spelling and linguistic conventions with regard to different conversation partners.

The more detailed flowchart for this alternative embodiment is illustrated in FIG. 6c. When the process starts 601, the user receives a message 603. As before, the message is parsed for key words 609 and those words are saved 617, but in this case the saved key words are indexed by the conversants (or conversation partners or corresponding text message exchangers or correspondents) as well as by the text modality. At this point, the message is displayed 605. (In some embodiments, it is spoken aloud by computer synthesized voice.) When the user wants to reply to this particular message (meaning that the focus is on this conversation or text exchange in a software program servicing this modality of messages), he or she must decide whether he or she intends to speak any key words 619. If so, the user activates an increase in probability that spoken words are matched to the key words (619) which changes the parameters in the speech recognition software to increase the probability of matching the speech to the key word or words 613. Then the user must decide if he or she wants to display the key words 621. Otherwise, at 619, the process by-passes 613 and moves directly to 621. If the user wants to display the key words for possible direct selection, he or she activates a display request 621 and the key words are shown on the dynamic display 615. At that point the process stops 607. On the other hand, if the user does not want to display the key words for direct selection 621, the process by-passes 615 and stops 607.

5. Combining Information from Incoming Text with Handwriting Recognition

This embodiment of the present invention is taught and described using FIG. 6a, FIG. 6b, and FIG. 6c as generally detailed above, but with the following changes to FIG. 6b and FIG. 6c and corresponding changes to the description of them.

For FIG. 6b: Change step 613 from “Change parameters in speech recognition software to increase the probability of matching speech to key word(s)” to “Change parameters in handwriting recognition software to increase the probability of matching handwriting to key word(s).”

For FIG. 6c: Change step 613 from “Change parameters in speech recognition software to increase the probability of matching speech to key word(s)” to “Change parameters in handwriting recognition software to increase the probability of matching handwriting to key word(s).” Also change step 619 from “User wants to speak key word(s) and activates increase in probability of matching to them?” to “User wants to hand write key word(s) and activates increase in probability of matching to them?”.

In an alternate embodiment, some or all of the user choices described above, are either preselected or made automatically.

6. Combining Information from Incoming Text with Word Prediction

This embodiment of the present invention is taught and described using FIG. 6a, FIG. 6b, and FIG. 6c as generally detailed above, but with the following changes to FIG. 6b and FIG. 6c and corresponding changes to the description of them.

For FIG. 6b: Change step 613 from “Change parameters in speech recognition software to increase the probability of matching speech to key word(s)” to “Change parameters in word prediction software to increase the probability of matching typing to key word(s).”

For FIG. 6c: Change step 613 from “Change parameters in speech recognition software to increase the probability of matching speech to key word(s)” to “Change parameters in word prediction software to increase the probability of matching typing to key word(s).” Also change step 619 from “User wants to speak key word(s) and activates increase in probability of matching to them?” to “User wants to type key word(s) and activates increase in probability of matching to them?”.

7. Combining Information from Incoming Text with Direct Selection of Words

This embodiment of the present invention is taught and described using FIG. 6a, FIG. 6b, and FIG. 6c as generally detailed above, but with the following changes to FIG. 6b and FIG. 6c and corresponding changes to the description of them.

For FIG. 6b: Eliminate step 613 so that step 611 leads directly to step 615.

For FIG. 6c: Eliminate step 613 and step 619, so that step 617 leads in all cases directly to step 621.

8. Combining Information from Conversation Logs with Speech Recognition

As taught above, some of the key words of a recently received message are likely to be incorporated in the response to it. In addition, a compendium of text messages from the ongoing text conversations between particular people will reveal not just key words, but key phrases that are often repeated. For example, parsing a message that includes the words “oh my God” may not suggest that these words are frequently used together—and since they are all short words, they might not even be flagged as key words. However, a comparison of messages between two users who commonly use this expression would identify this as a key phrase. This is particularly the case with technical phrases used in a business or field of endeavor that might not be common in everyday conversation. It is also the case with the phatic phrases and slang used among a particular group of friends in a specific medium or modality. For example, the phatic words and phrases used by two people in the SMS text messaging conversations between them may differ from the phatic words and phrases they use in the instant messaging or email between them.

The methods of comparing a series of bodies of text and identifying frequently used phrases are well known to practitioners of the art. The fact that this comparison includes not just the messages of one party, but responses to those messages by another party, increases the robustness of the comparison. This technique is used to develop a vocabulary set of key words and phrases that are likely to be utilized in any text message between two people that is distinct from the vocabulary set of key words from the most recent message. The most recent message presents words likely to be used in this specific conversation about a specific topic. A log of their many conversations presents words and phrases that are commonly used in many of the conversants' conversations.

By setting the parameters of the speech recognition software to limit itself to these communal key words and phrases or to increase the probability of matching to these communal key words and phrases, the accuracy of recognition is likely to be increased. In any event, logging the conversations is essential to comparing them. In a preferred embodiment all text exchanges (“conversations”) are logged. In an alternate embodiment, the original complete text of an exchange is deleted after a pre-specified time, or pre-specified number of exchanges, though the vocabulary set developed from analysis of those exchanges is not affected. In another embodiment, the vocabulary set reflects only the more recent exchanges, this allows the vocabulary set to evolve, just as slang, technical phrases, and phatic communications evolve.

FIG. 7a, FIG. 7b, and FIG. 7c illustrate this process. As the process in FIG. 7a starts 701, the system determines whether the text message is coming in, or whether it has been created by the user and is about to go out 703. If the system is receiving a text message 603, then the conversants are identified 709 from the message header or tags. The text of the message is logged and indexed by conversants (sender and receiver) 711. In this context, note that a user may have different instant message screen names, different email addresses, different cell phone numbers, etc. In other words, the individual who is receiving the message may have multiple identities, even accessed from the same device. That is why indexing by both the sender and the particular receiver identified in the message is important. The current just-received message is compared to previous messages in the log to identify key words and phrases 713. The key words and phrases are then indexed by the parties to the conversation (sender and receiver) 715.

In an alternate embodiment, the individual words and phrases in the displayed message (as identified through log analysis) are associated with a selectable field. The user is presented with a set of categories or tags used for direct selection, so that the user may associate (tag) individual words according to categories. In a preferred embodiment, the user highlights or otherwise placed focus on a particular word, then activates a “save” button or function, and then activates the desired tag or category. If the passage is being read aloud through computer synthesized voice (perhaps to an individual with reading disabilities), after one of the identified words or phrases is spoken (or highlighted and spoken), the user activates a “save” button or function, then activates the desired tag or category. This places the word or phrase in the category database for later display with the category of words or phrases.

The four distinct steps just noted will be referred to as the “Conversant key word and phrase module” 707, consisting of identifying the conversants 709, logging the message and indexing by the conversants 711, comparing the message to previous messages and identifying key words and phrases 713 and saving the key words and phrases indexed by the conversants 715.

After completing the conversant key word and phrase module (707), the process continues on FIG. 7b in anticipation of future user responses to this sender, with a change in the parameters in the speech recognition software to increase the probability of matching generalized speech to the key words and key phrases used by these conversants. 717.

The process then continues with the “vocabulary set key word and phrase module” 719. This consists of two distinct steps, searching the direct select vocabulary sets for the key words and phrases indexed in 715, and then indexing those key words and phrases by both vocabulary set and conversants 723. The point is that for many direct select categories, the user will want to employ different words or phrases, different slang and even spellings, different phatic and colloquialisms, depending on who is on the other end of the text conversation.

After completing the vocabulary set key word and phrase module 719, this indexing in anticipation of future user responses is used to enhance the accuracy of the speech recognition by changing the parameters in the speech recognition software to increase the probability of matching speech to key words or phrases with respect to those used by these conversants in each particular direct select vocabulary set 725.

The process then continues on FIG. 7c in anticipation of user responses, as the generalized key words and phrases are displayed for direct selection 729 with key words and phrases indexed by conversants (which were recalculated in the conversant key word and phrase module 707). Then the system displays an access to the direct select vocabulary sets (recalculated in the vocabulary set key word and phrase module 731). After this, the message that was received in 603 is displayed 605. In many current computer systems, steps 729, 731 and 605 occur in rapid succession and appear to the user to occur almost simultaneously. The process then stops 735.

On the other hand, if in step 703 the message was going out, then the system accepts the message being sent 705 and invokes the conversant key word and phrase module 707. As shown, this module includes the steps of identifying the parties to the text message conversation 709, logging the message about to be sent and indexing by the parties to the conversation 711, comparing this message with previous messages to identify key words and phrases 713, and saving the key words and phases indexed by the parties to the conversation 715.

This process continues on FIG. 7b, by using the information gained in the conversant key word and phrase module 707 to change parameters in the speech recognition software to increase the probability of matching generalized speech to the key words and key phrases used by these parties to the conversation 717.

The vocabulary set key word and phrase module 719 is then invoked. As shown in FIG. 7b, this module 719 consists of two steps, searching the direct select vocabulary sets of the key words and phrases (721) that had been identified in the conversant key word and phrase module 707, and then indexing the key words and phrase by both the vocabulary set and by the parties to the conversation 723.

After completing the vocabulary set key word and phrase module 719, the next step is to change the parameters in the speech recognition software to increase the probability of matching the speech to key words and key phrases used by these parties to a conversation in each particular direct select vocabulary set. 725.

The process continues on FIG. 7c by sending the message 727 that had been accepted for sending in 705. At this point, the process stops 732.

Notice that whether the system receives a message 603 in FIG. 7a, or accepts a message to go out 705, the preferred embodiment illustrated in FIG. 7a, FIG. 7b, and FIG. 7c, invokes many of the same steps: 707 (including 709, 711, 713, 715), 717, 719 (including 721 and 723) and 725.

In an alternate embodiment, the user can select when the speech recognition software focuses on key words and phrases used in text message conversations with this conversation partner and when it tries to recognize words without such limitation. This increases recognition accuracy in two ways. When the user wishes to speak sentences containing words or phrases often spoken in conversations with this conversation partner, he or she can increase accuracy as described above and illustrated in the flowcharts of FIG. 7a, FIG. 7b, and FIG. 7c. But when the user speaks on a new topic with new words, accuracy is not decreased by focusing on the words in the received message. In fact, in an alternate embodiment, the act of not focusing on the words in the received message will change the parameters in the speech recognition software to decrease the probability of matching to those words. Consequently, accuracy is increased in this instance as well.

FIG. 8a and FIG. 8b illustrate this process. When the process starts 801, the system assesses whether a text message is coming in, or whether the system is ready for the user to compose a message to be sent. Suppose that the system is receiving a text message 603, then the process continues on FIG. 8b with the conversant key word and phrase module 707 and the vocabulary set key word and phrase module 719. Although these modules identify key words and phrases, no changes in speech recognition parameters are made at this time. Those changes occur when invoked by the user when composing a message.

In preparation for a possible reply, the dynamic display then shows the generalized key words which the user can direct select 729. The dynamic display also shows direct access to the direct select vocabulary sets with key words and phrases indexed by conversants 731, then displays the text message 605 that had been received 603 in FIG. 8a. (In some embodiments and as mentioned previously, display of the message 605 includes having the computer speak the message aloud through computer synthesized speech.) Then the process stops, 813.

On the other hand, when the user is composing a text message or preparing to compose a text message the process at step 803 may take the “no” branch. Then, if the user wants to speak generalized key words or phrases with respect to the person to whom the message is intended to be sent, then the user activates an increase in probability of matching to them 805. This changes the parameters in the speech recognition software to increase the probability of matching generalized speech to the key words and key phrases used by these conversants 717, and the user composes the message to go out 809. Not shown is that this act of composition is through the user speaking, and the speech recognition technology seeking best matches to the user's utterance.

However, the user may instead know that the text message primarily employs a specific vocabulary set, in which case the user chooses a vocabulary set before speaking the utterance that contains key words and phrases that are used in this vocabulary set by these conversants 807. This changes the parameters in the speech recognition software to increase the probability of matching speech to key words and phrases used by these conversants in the invoked particular direct selection vocabulary set 725, and the user composes the message 809 as before.

Of course, the user may instead know that the message contains sufficient new matter that any key words and phases used in past text exchanges with this person are less likely to be used, in which case the user does not choose 805 or 807 and just composes the message 809 by speaking it.

The process then continues on FIG. 8b, as the user finishes the message to be sent 811. Then the system invokes the conversant key word and phrase module 707 and the vocabulary set key word and phrase module 719, to identify and index key words and phrases, before sending the message 727 and stopping 813.

In an alternate embodiment, the user composes the message 809 a phrase at a time. For some phrases the user activates enhanced recognition of general key words and phrases between the participants (805 and 717), for others the user chooses a vocabulary which further restricts key words and phrases (807 and 725), and for still others activates no enhanced recognition features (the “no” branch of 807). In this embodiment, the user loops through these steps illustrated in FIG. 8a until the message is complete, then proceeds to FIG. 8b.

9. Combining Information from Conversation Logs with Handwriting Recognition

This embodiment of the present invention is taught and described using FIG. 7a, FIG. 7b, FIG. 7c, FIG. 8a, and FIG. 8b as generally detailed above, but with the following changes to FIG. 7b and FIG. 8a and corresponding changes to the description of them.

For FIG. 7b: Change both instances of step 717 from “Change parameters in speech recognition software to increase the probability of matching generalized speech to key word(s) and key phrase(s) used by these conversants” to “Change parameters in handwriting recognition software to increase the probability of matching generalized handwriting to key word(s) and key phrase(s) used by these conversants”.

Also change both instances of step 725 from “Change parameters in speech recognition software to increase the probability of matching speech to key word(s) and key phrase(s) used by these conversants in each particular direct select vocabulary set” to “Change parameters in handwriting recognition software to increase the probability of matching handwriting to key word(s) and key phrase(s) used by these conversants in each particular direct select vocabulary set”.

For FIG. 8a: Change step 717 from “Change parameters in speech recognition software to increase the probability of matching generalized speech to key word(s) and key phrase(s) used by these conversants” to “Change parameters in handwriting recognition software to increase the probability of matching generalized handwriting to key word(s) and key phrase(s) used by these conversants”.

Also change step 725 from “Change parameters in speech recognition software to increase the probability of matching speech to key word(s) and key phrase(s) used by these conversants in each particular direct select vocabulary set” to “Change parameters in handwriting recognition software to increase the probability of matching handwriting to key word(s) and key phrase(s) used by these conversants in each particular direct select vocabulary set”.

Also change step 805 from “User wants to speak generalized key word(s) or phrase(s) and activates increase in probability of matching to them?” to “User wants to hand write generalized key word(s) or phrase(s) and activates increase in probability of matching to them?”

Also change step 807 from “User chooses a vocabulary set before speaking key word(s) or phrase(s)?” to “User chooses a vocabulary set before handwriting key word(s) or phrase(s)?”.

Also change in the description of step 809 that this act of composition is through the user writing, and the handwriting recognition technology seeking best matches to the user's handwriting.

10. Combining Information from Conversation Logs with Word Prediction

This embodiment of the present invention is taught and described using FIG. 7a, FIG. 7b, FIG. 7c , FIG. 8a, and FIG. 8b as generally detailed above, but with the following changes to FIG. 7b and FIG. 8a and corresponding changes to the description of them.

For FIG. 7b: Change both instances of step 717 from “Change parameters in speech recognition software to increase the probability of matching generalized speech to key word(s) and key phrase(s) used by these conversants” to “Change parameters in word prediction software to increase the probability of matching generalized typing to key word(s) and key phrase(s) used by these conversants”.

Also change both instances of step 725 from “Change parameters in speech recognition software to increase the probability of matching speech to key word(s) and key phrase(s) used by these conversants in each particular direct select vocabulary set” to “Change parameters in word prediction software to increase the probability of matching typing to key word(s) and key phrase(s) used by these conversants in each particular direct select vocabulary set”.

For FIG. 8a: Change step 717 from “Change parameters in speech recognition software to increase the probability of matching generalized speech to key word(s) and key phrase(s) used by these conversants” to “Change parameters in word prediction software to increase the probability of matching generalized typing to key word(s) and key phrase(s) used by these conversants”.

Also change step 725 from “Change parameters in speech recognition software to increase the probability of matching speech to key word(s) and key phrase(s) used by these conversants in each particular direct select vocabulary set” to “Change parameters in word prediction software to increase the probability of matching typing to key word(s) and key phrase(s) used by these conversants in each particular direct select vocabulary set”.

Also change step 805 from “User wants to speak generalized key word(s) or phrase(s) and activates increase in probability of matching to them?” to “User wants to type generalized key word(s) or phrase(s) and activates increase in probability of matching to them?”

Also change step 807 from “User chooses a vocabulary set before speaking key word(s) or phrase(s)?” to “User chooses a vocabulary set before typing key word(s) or phrase(s)?”.

Also change in the description of step 809 that this act of composition is through the user typing, and the word prediction technology seeking best matches to the user's typing.

11. Combining Information from Conversation Logs with Direct Selection of Words

This embodiment of the present invention is taught and described using FIG. 7a, FIG. 7b, FIG. 7c, FIG. 8a, and FIG. 8b as generally detailed above, but with the following changes to FIG. 7b and FIG. 8a and corresponding changes to the description of them.

For FIG. 7b: Eliminate both instances of step 717 so that when the process at step 715 in FIG. 7a, continues to FIG. 7b (whether through “A” or “B”), it directly proceeds to step 721.

Also eliminate both instances of step 725 so that when the process at step 723 in FIG. 7b, continues to FIG. 7c through “C” it directly proceeds to step 727, and when the process at step 723 in FIG. 7b, continues to FIG. 7c through “D” it directly proceeds to step 729.

For FIG. 8a: Change step 805 from “User wants to speak generalized key word(s) or phrase(s) and activates increase in probability of matching to them?” to “User directly selects vocabulary set of generalized key word(s) or phrase(s)?”

Also change step 807 from “User chooses a vocabulary set of conversant indexed key word(s) and phrase(s) before speaking?” to “User directly selects a vocabulary set of conversant indexed key word(s) and phrase(s)?”.

Also eliminate step 717 so that when the process at step 805 follows the “yes” branch, it proceeds directly to step 809.

Also eliminate step 725 so that when the process at step 807 follows the “yes” branch, it proceeds directly to step 809.

Also change the description of step 809 that this act of composition is through the user's direct selection.

12. Combining Non-Pictorial Graphical Patterns or Designs that Singly or in Combination Clearly and Uniquely Identify Each of the Words or Text Objects in the Target Set

The purpose of this embodiment is to allow the user to employ his or her other non-reading abilities to remember which button or activate-able area on a display screen stands for which particular word.

Some individuals have difficulty reading a word, even if they know what a word means and can use it in a sentence. In the past decade it has been scientifically demonstrated that some reading disabilities such as dyslexia are due to imperfections in specific brain circuitry of the affected individuals, but that other brain circuits, functions and intelligences may not be affected. This is one reason why some assistive technologies (such as AAC devices) use graphical inputs, e.g. a button that “speaks” the word “house” shows a picture of a house, along with or instead of the text of the word “house”. For people with a frozen vocal box who need to use an AAC device to speak, when the button is activated, the device or software speaks the word aloud using a computer synthesized voice. When the button speaks the word, the software or device also provides the word as a text object for composing a message. However there are many words, especially in casual speech, that have the same meaning but different spellings and soundings (e.g. “yes”, “yeah”, “yep”, “yup”) or very similar meanings (e.g. “yes”, “right”, “righto”, “alright”, “ok”, “exactly”), not to mention the slang which acquires new meaning in a particular” context, or with particular conversants (e.g. in some contexts, the word “bad” means the same as “good”).

Users who cannot read words, may remember distinct colors and patterns, but assistive technologies are already using colors for other specific purposes. Sometimes buttons for related words (e.g. action words) are grouped by having the same background color, so that the user can more easily find the right button. Some AAC devices show buttons with shaded bevels, so that the button looks more realistic or three-dimensional, but also so that the color of the bevel can be different from the background color of the button, allowing the graphical user interface on the dynamic display to show a more complex relationship between the buttons (or more accurately, between the words on the buttons).

In a preferred embodiment of the present invention, every button has a distinct pattern. This is regardless of the particular layout of the buttons, whether in a row, in a column, in a grid, or scattered on a screen.

FIG. 9a illustrates a column 901 of four buttons (903, 905, 907, and 909) with four distinct patters as they are displayed on a screen or dynamic display. The pattern on 903 consists of parallel lines drawn at 45 degrees to the vertical (and horizontal). The pattern on 905 consists of parallel zigzag lines that zigzag along horizontal axes. The pattern on 907 consists of parallel horizontal lines. The pattern on 909 consists of parallel wavy lines, each along a horizontal axis.

FIG. 9b shows a similar column 911 of four buttons (913, 915, 917, and 919) with the same four distinct patterns, but also with a distinct word or phrase on each button. Button 913 has the same pattern as button 903, but also has the word “What?!” Button 915 has the same pattern as button 905, but also the word “Yikes!” Button 917 has the same pattern as button 907, but also the phrase, “Oh my gosh.” Button 919 has the same pattern as button 909, but also the word “Wow.” Notice that all of these words and phrases have a similar meaning, that linguistically they all are interjections indicating surprise, and that they cannot be distinguished by pictures of objects. Nonetheless a user who remembers the distinct patterns on the buttons remembers which button to press to have the device “speak” any particular one of these words—even if the user cannot read the words. When any button is activated the device or software can also provide the word or phrase as a text object for composing a message. The pattern differentiation also helps a poor reader, because the user employs both his memory of patterns and his limited ability with words to remember which word is where.

When a user simply cannot read, the buttons in FIG. 9a are just as useful as those in FIG. 9b. Also, each button has a distinct pattern regardless of what color the background or bevel of the buttons might be. Consider a series of screens for different vocabulary sets. In this way, a series of screens of four buttons in a column (or row) might have different words and different colors, but the locational patterns may remain the same for each set, so that a user may remember a word by remembering the vocabulary set and the location (by pattern) on the page for that set.

As is well known to practitioners of the art, a variety of patterns can be used to effectuate the preferred embodiments of the present invention, and this teaching is not limited to any particular set of patterns used in the figures or described in the text.

In an alternative embodiment of the present invention, the buttons are arranged in a grid and every button has a distinct pattern which indicates the row and column in which the button is located.

FIG. 10a shows 16 buttons laid out in a grid 1001 of four rows (1003, 1005, 1007, and 1009) and four columns. Every button in a particular row has the same pattern, but that the pattern in every row is different. Row 1003 has the same pattern as 903 (in FIG. 9a). Row 1005 has the same pattern as 905 (in FIG. 9a). Row 1007 has the same pattern as 907 (in FIG. 9a). Row 1009 has the same pattern as 909 (in FIG. 9a).

FIG. 10b shows 16 buttons laid out in a grid 1011 of four rows (1013, 1015, 1017, and 1019) and four columns (1023, 1025, 1027, and 1029), and each button has a distinct pattern. This pattern was made by taking FIG. 10a, rotating it 90 degrees counterclockwise, and superimposing that four by four grid upon the original FIG. 10a. In other words, each button of FIG. 10b has a pattern that consists of two underlying patterns: one pattern unique to its row, and another unique to its column. Row 1013 has the same pattern as 1003 (in FIG. 10a). Row 1015 has the same pattern as 1005 (in FIG. 10a). Row 1017 has the same pattern as 1007 (in FIG. 10a). Row 1019 has the same pattern as 1009 (in FIG. 10a). At the same time, column 1013 has the same pattern as 1003 (in FIG. 10a) rotated 90 degrees counterclockwise. Column 1015 has the same pattern as 1005 (in FIG. 10a) rotated 90 degrees counterclockwise. Column 1017 has the same pattern as 1007 (in FIG. 10a) rotated 90 degrees counterclockwise. Column 1019 has the same pattern as 1009 (in FIG. 10a) rotated 90 degrees counterclockwise.

FIG. 10c shows 16 buttons laid out in a grid 1031 of four rows and four columns, where each button has a distinct pattern identical to the patterns in FIG. 10b, but also has a word or phrase written on that button. In this example, notice that all of these words and phrases have a similar meaning, that linguistically they all are interjections indicating surprise, and that they cannot generally be distinguished by pictures of objects. Nonetheless a user who remembers the distinct patterns on the buttons, or the row and column of each particular button, remembers which button to press to have the device “speak” any particular one of these words—even if the user cannot read the words. Likewise the user remembers which button will produce the text object for a word, even if the user cannot read it. The pattern differentiation also helps a poor reader, because the user employs both his memory of patterns and his limited ability with words to remember which word is where.

When a user simply cannot read, the buttons in FIG. 10b are just as useful as those in FIG. 10c. Also, each button has a distinct pattern regardless of what color the background or bevel of the buttons might be. In this way, a series of screens four by four grids of buttons might have different words and different colors, but the location (which row and column of that screen) is remembered as distinct.

In an alternative embodiment, the row component of button patterns is not related to the column component of button patterns, but again providing that each button has a distinct pattern that also indicates in which row and column the button is related.

As is well known to practitioners of the art, a variety of patterns can be used to effectuate the preferred embodiments of the present invention, and this teaching is not limited to any particular set of patterns used in the figures or described in the text.

In an alternative embodiment of the present invention, each button in a grid also has a distinct pattern with two components, one unique to the row and the other unique to the column, but in which one of the components is displayed in the button background and another is displayed in the button's bevel.

FIG. 11a shows 16 buttons laid out in a grid 1101 of four rows (1103, 1105, 1107, and 1109) and four columns (1111, 1113, 1115, and 1117), and each button has a distinct pattern. This pattern was made by using the same patterns for button backgrounds as in FIG. 10a but also putting a different background on the bevels for every column. In other words, each button of FIG. 11a has a pattern that consists of two underlying patterns: one pattern unique to its row, and another unique to its column. Row 1103 has the same pattern as 1003 (in FIG. 10a). Row 1105 has the same pattern as 1005 (in FIG. 10a). Row 1107 has the same pattern as 1007 (in FIG. 10a). Row 1109 has the same pattern as 1009 (in FIG. 10a). At the same time, every button column 1111 has a bevel with the same blank pattern. The bevels in column 1113 have the same pattern, here tiny cross-hatchings. The bevels in column 1115 have the same pattern, here a tiny stipple pattern. The bevels in column 1117 have the same pattern, here a squiggly pattern.

FIG. 11b shows 16 buttons laid out in a grid 1121 of four rows and four columns, where each button has a distinct pattern identical to the patterns in FIG. 11a, but also has a word or phrase written on that button. In this example, notice that all of these words and phrases are the same as those used to illustrate FIG. 10c and all have a similar meaning or similar emotive content, that linguistically they all are interjections indicating surprise, and that they cannot generally be distinguished by pictures of objects. Nonetheless a user who remembers the distinct patterns on the buttons, or the row and column of each particular button, remembers which button to press to have the device “speak” any particular one of these words—even if the user cannot read the words. Likewise the user remembers which button will produce the text object for a word, even if the user cannot read it. The pattern differentiation also helps a poor reader, because the user employs both his memory of patterns and his limited ability with words to remember which word is where.

When a user simply cannot read, the buttons in FIG. 11a are just as useful as those in FIG. 11b. Also, each button has a distinct pattern regardless of what color the background or bevel of the buttons might be. In this way, a series of screens four by four grids of buttons might have different words and different colors, but the location (which row and column of that screen) is remembered as distinct.

FIG. 11a and FIG. 11b show all bevels in a single column as having the same pattern and all backgrounds in a single row as having the same pattern. In an alternate embodiment, these are switched so that all bevels in a single row have the same pattern and all backgrounds in a single column have the same pattern.

As is well known to practitioners of the art, a variety of patterns can be used to effectuate the preferred embodiments of the present invention, and this teaching is not limited to any particular set of patterns used in the figures or described in the text.

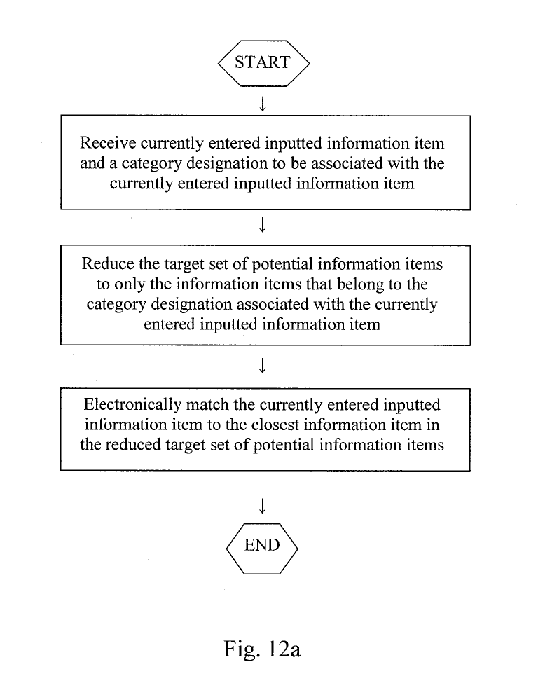

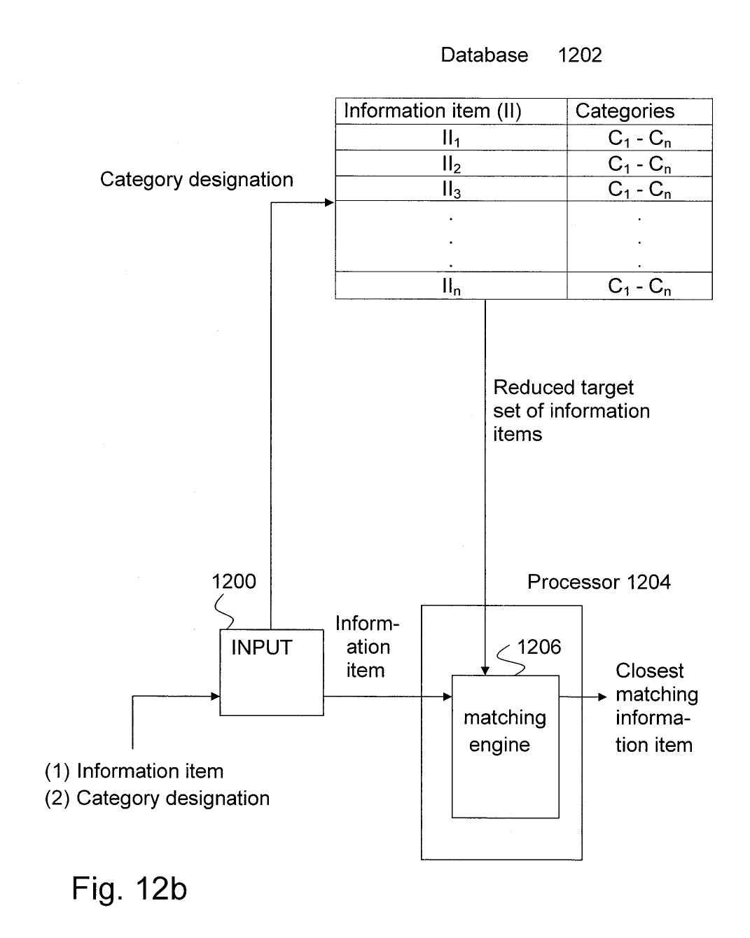

FIG. 12a is a self-explanatory flowchart that shows one preferred embodiment of an automated method of recognizing an inputted information item by matching the inputted information item to a target set of potential information items stored in a database.

FIG. 12b is a schematic diagram of the hardware/software elements for implementing the flowchart of FIG. 12b. The elements include an input 1200 that receives an information item and a category designation (which can be received either manually or automatically as discussed above), a database 1202 and a processor 1204 that includes a matching engine 1206. The category designation is used by the database 1202 to identify a reduced target set of information items which is sent to the matching engine 1206 of the processor 1204. The matching engine identifies the closest matching information item. As discussed above, a category may include any of the following:

1. types of categories

2. demographic-based categories

3. modality-based categories

4. phatic communication categories

5. recently entered information items

6. previously entered information items

An information item thus may belong to a plurality of categories. Recently entered and previously entered information items may be specific to a particular user or set of users (e.g., information items recently entered by “Jane Doe” or recently entered by members of a specific chat session).

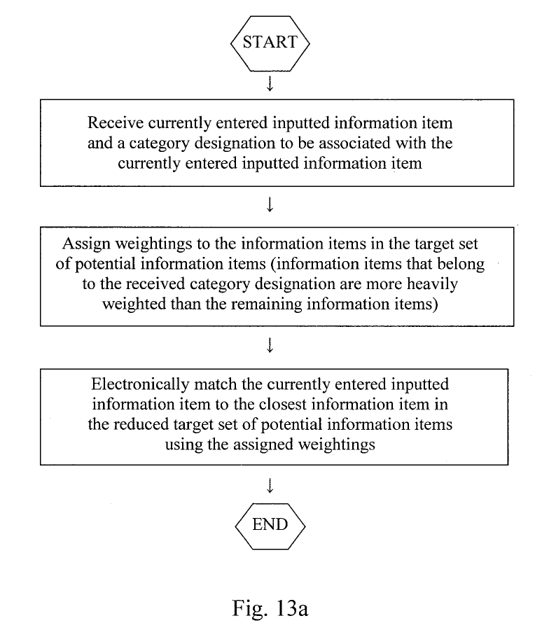

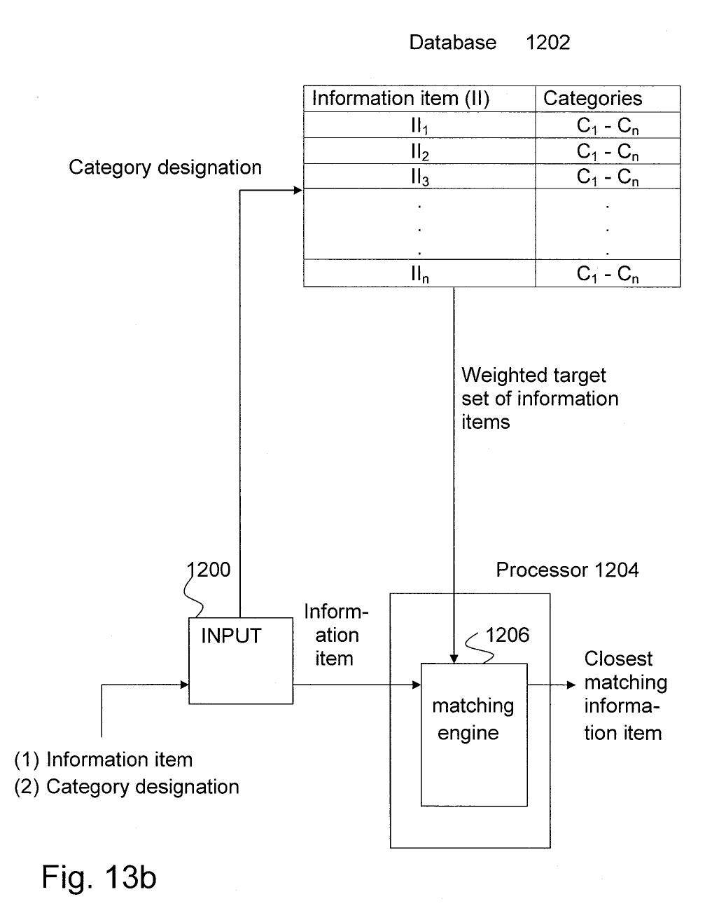

FIG. 13a is a self-explanatory flowchart that shows one preferred embodiment of an automated method of recognizing an inputted information item by matching the inputted information item to a target set of potential information items stored in a database.

FIG. 13b is a schematic diagram of the hardware/software elements for implementing the flowchart of FIG. 13a. FIG. 13b is similar to FIG. 12b, except that the category designation is used by the database 1202 to assign weightings to all of the information items, instead of identifying a reduced target set of information items.

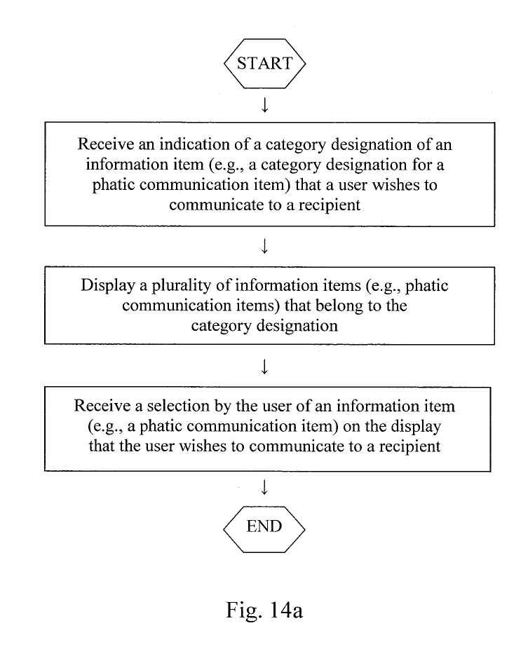

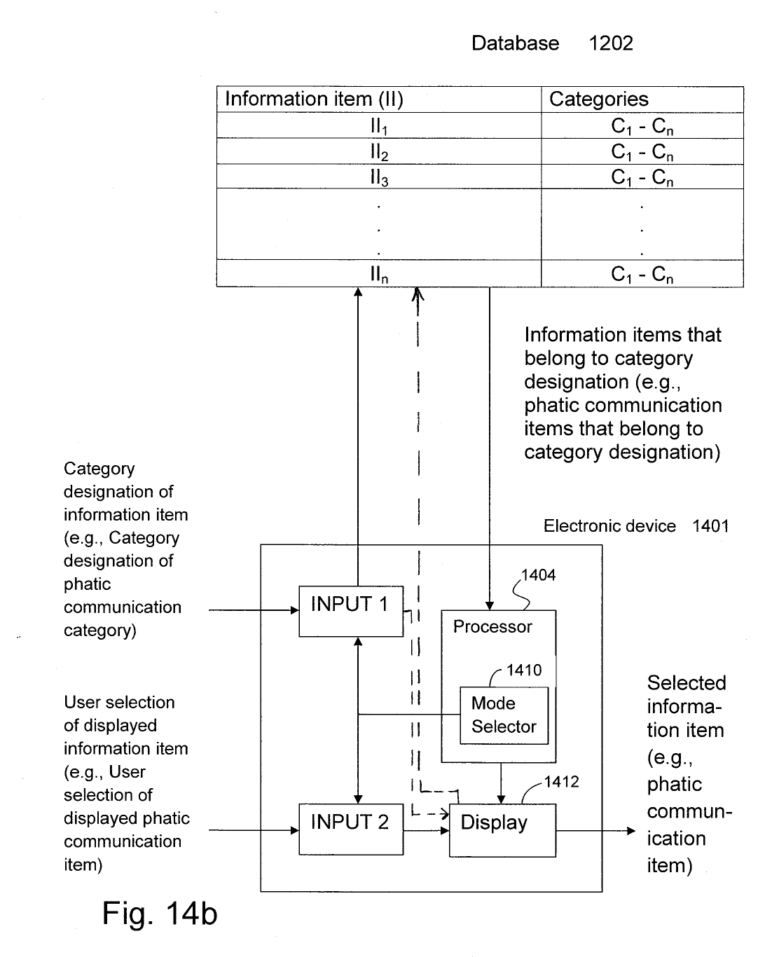

FIG. 14a is a self-explanatory flowchart that shows one preferred embodiment of a method for allowing a user to select an information item displayed on an electronic device for communicating the information item to a recipient. In one preferred embodiment, the information is a phatic communication item.

FIG. 14b is a schematic diagram of the hardware/software elements for implementing the flowchart of FIG. 14a. The elements include the database 1202 and an electronic device 1401. The electronic device 1401 includes inputs 1 and 2, a processor 1410 that includes a mode selector 1410, and a display 1412. The mode selector 1410 has a first selection mode wherein a category designation of an information item (e.g., a phatic communication item) is selected via input 1 and a second selection mode wherein an information item (e.g., a phatic communication item) is selected via input 2. In one embodiment, input 1 is made by a selection of information shown on the display 1412, as shown in the dashed lines of FIG. 14b. In other embodiments, non-display input methods are used to make the input 1 selection.

The processors 1204, 1402, matching engine 1206 and mode selector 1410 shown in FIGS. 12b, 13b and 14b may be part of one or multiple general-purpose computers, such as personal computers (PC) that run a Microsoft Windows® or UNIX® operating system, or they may be part of server-based computers.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer readable storage media. The storage media is encoded with computer readable program code for providing and facilitating the mechanisms of the present invention. The article of manufacture can be included as part of a computer system or sold separately.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention.

While the present invention has been particularly shown and described with reference to one preferred embodiment thereof, it will be understood by those skilled in the art that various alterations in form and detail may be made therein without departing from the spirit and scope of the present invention.

What is claimed is:

1. An automated method of recognizing an inputted information item by matching the inputted information item to a target set of potential information items stored in a database, wherein at least some of the information items in the target set of potential information items is indicated in the database as belonging to one or more different categories, the method comprising:
(a) receiving in a processor:
(i) a currently entered inputted information item, and
(ii) a category designation to be associated with the currently entered inputted information item;
(b) reducing the target set of potential information items to only the information items that belong to the category designation associated with the currently entered inputted information item; and
(c) electronically matching, using the processor, the currently entered inputted information item to the closest information item in the reduced target set of potential information items.

2. The method of claim 1 further comprising:
(d) tracking recently entered inputted information items that were entered by a specific user, wherein one of the categories to which potential information items are indicated in the database as belonging is recently entered inputted information items that were entered by a specific user, and wherein the processor is configured to receive in step (a)(ii) a category designation of recently entered inputted information items that were entered by a specific user.

3. The method of claim 2 wherein the receipt of the category designation in step (a)(ii) occurs automatically.

4. The method of claim 3 wherein the categories include demographic-based categories.

5. The method of claim 1 further comprising:
(d) tracking previously entered inputted information items that were entered by a specific user, wherein one of the categories to which potential information items are indicated in the database as belonging is previously entered inputted information items that were entered by a specific user, and wherein the processor is configured to receive in step (a)(ii) a category designation of previously entered inputted information items that were entered by a specific user.

6. The method of claim 5 wherein the receipt of the category designation in step (a)(ii) occurs automatically.

7. The method of claim 6 wherein the categories include demographic-based categories.

8. The method of claim 1 wherein the inputted information item is a spoken utterance and the target set of potential information items is a target set of potential utterances.

9. The method of claim 1 wherein the inputted information item is a handwritten expression and the target set of potential information items is a target set of potential textural expressions.

10. The method of claim 1 wherein the inputted information item is a typed expression and the target set of potential information items is a target set of potential typed expressions.

11. The method of claim 1 wherein the categories include types of categories.

12. The method of claim 1 wherein the categories include demographic-based categories.

13. The method of claim 1 wherein the categories include modality-based categories.

14. The method of claim 1 wherein the categories include phatic communication categories.

15. An automated method of recognizing an inputted information item by matching the inputted information item to a target set of potential information items stored in a database, wherein at least some of the information items in the target set of potential information items is indicated in the database as belonging to one or more different categories, the method comprising:
(a) receiving in a processor:
(i) a currently entered inputted information item, and
(ii) a category designation to be associated with the currently entered inputted information item;
(b) assigning weightings to the information items in the target set of potential information items, wherein the information items that belong to the category designation received in step (a)(ii) are more heavily weighted than the remaining information items; and
(c) electronically matching, using the processor, the currently entered inputted information item to the closest information item in the target set of potential information items, wherein the assigned weightings are used when determining the closest match.

16. The method of claim 15 further comprising:
(d) tracking recently entered inputted information items that were entered by a specific user, wherein one of the categories to which potential information items are indicated in the database as belonging is recently entered inputted information items that were entered by a specific user, and wherein the processor is configured to receive in step (a)(ii) a category designation of recently entered inputted information items that were entered by a specific user.

17. The method of claim 16 wherein the receipt of the category designation in step (a)(ii) occurs automatically.

18. The method of claim 17 wherein the categories include demographic-based categories.

19. The method of claim 15 further comprising:
(d) tracking previously entered inputted information items that were entered by a specific user, wherein one of the categories to which potential information items are indicated in the database as belonging is previously entered inputted information items that were entered by a specific user, and wherein the processor is configured to receive in step (a)(ii) a category designation of previously entered inputted information items that were entered by a specific user.

20. The method of claim 19 wherein the receipt of the category designation in step (a)(ii) occurs automatically.

21. The method of claim 20 wherein the categories include demographic-based categories.

22. The method of claim 15 wherein the inputted information item is a spoken utterance and the target set of potential information items is a target set of potential utterances.

23. The method of claim 15 wherein the inputted information item is a handwritten expression and the target set of potential information items is a target set of potential textural expressions.

24. The method of claim 15 wherein the inputted information item is a typed expression and the target set of potential information items is a target set of potential typed expressions.

25. The method of claim 15 wherein the categories include types of categories.

26. The method of claim 15 wherein the categories include demographic-based categories.

27. The method of claim 15 wherein the categories include modality-based categories.

28. The method of claim 15 wherein the categories include phatic communication categories.

29. A method for allowing a user to select a phatic communication item displayed on an electronic device for communicating the phatic communication item to a recipient, the electronic device being in communication with a database of phatic communication items, at least some of the phatic communication items being indicated in the database as belonging to one or more different categories, the electronic device having (i) a first selection mode wherein a category designation of a phatic communication item is selected, (ii) a second selection mode wherein a phatic communication item is selected, and (iii) a display, the method comprising:
(a) receiving by the electronic device when the electronic device is in the first selection mode an indication of the category designation of a phatic communication item that the user wishes to select; and
(b) displaying on the display a plurality of phatic communication items that belong to the category designation; and
(c) receiving by the electronic device when the electronic device is in the second selection mode a selection by the user of one of the plurality of phatic communication items on the display that the user wishes to communicate to a recipient.

30. The method claim 29 wherein step (a) further comprises displaying on the display a plurality of category designations for selection by the user when the electronic device is in the first selection mode.

31. The method of claim 30 wherein the plurality of category designations displayed on the display when the electronic device is in the first selection mode include non-pictorial graphical patterns or designs that singly or in combination clearly and uniquely identify a specific category designation.

32. The method of claim 29 wherein the plurality of phatic communication items displayed on the display in step (b) include non-pictorial graphical patterns or designs that singly or in combination clearly and uniquely identify a specific phatic communication item.

33. The method of claim 29 wherein the plurality of phatic communication items displayed on the display in step (b) convey similar emotive content so that regardless of which selection is made in step (c), a similar emotive message is communicated to the recipient.

34. The method of claim 29 wherein the phatic communication items are textural expressions.

35. The method of claim 29 wherein the categories include types of categories.

36. The method of claim 29 wherein the categories include demographic-based categories.

37. The method of claim 29 wherein the categories include modality-based categories.

38. The method of claim 29 wherein the database further includes recently entered inputted phatic communication items that were entered by a specific user, wherein one of the categories is recently entered inputted phatic communication items that were entered by a specific user, and wherein step (a) further comprises receiving by the electronic device a category designation of recently entered inputted phatic communication items that were entered by a specific user.

39. The method of claim 29 wherein the database further includes previously entered inputted phatic communication items that were entered by a specific user, wherein one of the categories is previously entered inputted phatic communication items that were entered by a specific user, and wherein step (a) further comprises receiving by the electronic device a category designation of previously entered inputted phatic communication items that were entered by a specific user.

40. The method of claim 29 wherein the categories include phatic communication categories.
